(19) United States
(12) Patent Application Publication
(10) Pub. No.: US 2015/0278710 A1
(43) Pub. Date: Oct. 1, 2015

(54) MACHINE LEARNING APPARATUS, MACHINE LEARNING METHOD, AND NON-TRANSITORY COMPUTER-READABLE RECORDING MEDIUM

(71) Applicant: NEC Corporation, Tokyo (JP)

(72) Inventor: Daichi HISADA, Tokyo (JP)

(73) Assignee: NEC Corporation, Tokyo (JP)

(21) Appl. No.: 14/666,882

(22) Filed: Mar. 24, 2015

(30) Foreign Application Priority Data
Mar. 26, 2014 (JP) 2014-064173

(51) Int. Cl. G06N 99/00

(52) U.S. Cl. CPC G06N 99/005

(57) ABSTRACT

A machine learning apparatus (100) including: a feature calculation unit (11) that transforms, into first numerical data sets, training data sets to each of which either one of two values is added; a support vector machine learning unit (21) that learns, based on the first numerical data sets, a criterion for classification of the two values, creating a learning model; a self-organizing map learning unit (22) that projects the first numerical data sets onto a two-dimensional map, the two-dimensional map having blocks and representative data sets, wherein the self-organizing map learning unit (22) causes, first numerical data sets with a short distance from each other to belong to adjacent blocks; a support vector machine classifying unit (25) that classifies, by using the learning model, the blocks and the representative data sets; and a learning model two-dimensionalization unit (31) that creates a two-dimensional learning model representing the results of the classification.

### CROSS-REFERENCE TO RELATED APPLICATION

This application is based upon and claims the benefit of priority from Japanese patent application No. 2014-64173, filed on Mar. 26, 2014, the disclosure of which is incorporated herein in its entirety by reference.

### BACKGROUND OF THE INVENTION

1. Field of the Invention

The present invention relates to a machine learning apparatus, a machine learning method, and a non-transitory computer-readable recording medium storing a program for implementing them.

2. Background Art

Machine learning is a type of artificial intelligence that provides a computer with the ability to “learn”. Machine learning allows for estimating the properties of a given data set. Therefore, information provided by machine learning is useful for prediction-making (see Prior Art Document 1 for example).
Prior Art Document 1: Toby Segaran, “Collective Intelligence”, REILLY, pp. 3, 2007

In machine learning, analysis of the properties of a data set given by a user is referred to as “learning by a learner”. A “learner” is a system implementing some sort of machine learning method. Here, a description is given to a system implementing a conventional machine learning scheme with reference to FIGS. 16A through 18B. FIGS. 16A and 16B are diagrams illustrating usage example 1 of a system implementing a conventional machine learning scheme. FIGS. 17A and 17B are diagrams illustrating usage example 2 of a system implementing a conventional machine learning scheme. FIGS. 18A and 18B are diagrams illustrating usage example 3 of a system implementing a conventional machine learning scheme.

In the usage example 1, as shown in FIG. 16A, the learner learns sensor data, including the values of atmospheric temperature, humidity, wind direction, and atmospheric pressure at the present time and the time that is 24 hours before the present time. As shown in FIG. 16B, upon receiving sensor data including the atmospheric temperature, humidity, wind direction, and atmospheric pressure, the learner outputs a predicted value of the atmospheric temperature at the time that is 24 hours after the present time.

In the usage example 2, as shown in FIG. 17A, the learner learns the occurrence frequency of words contained in mail documents. As shown in FIG. 17B, upon receiving a mail, the learner categorizes the mail as a spam mail or a normal mail.

In the usage example 3, as shown in FIG. 18A, the learner learns purchase information of customers. As shown in FIG. 18B, upon receiving the purchase information of a customer, the learner categorizes the customer into a customer group showing the customer's purchasing trend.

Such machine learning tasks are classified into two types, namely unsupervised machine learning and supervised machine learning. Unsupervised machine learning is a task of learning using only the data provided by a user. On the other hand, supervised machine learning is a task of learning using training data as well. Note that “training data” is data to be learned, to which values determined by the user have been added.

As can be seen from the above, the two types of machine learning differ from each other in that whether the learner has been given by the user the correct values that are expected to be output with respect to a given data set. Therefore, when the user has some knowledge about the data set to be analyzed and knows the values expected to be obtained through machine learning, supervised machine learning is used. On the other hand, when the user does not have knowledge about the data set to be analyzed and does not know what analysis should be performed by using the learner, unsupervised machine learning is used.

One usage example of the supervised machine learning is the system of outputting a predicted temperature at 24 hours after the present time, which is shown in FIG. 16A and FIG. 16B described above. In the case of this system, training data is obtained by adding, to past sensor data, data obtained at the time that is 24 hours later than the past sensor data. The supervised learner, upon being provided with this training data, learns the trends in the training data. Thus, the use of a trained learner allows for prediction of the temperature at given time in the future.

One usage example of unsupervised machine learning is the system of classifying customers into categories, which is shown in FIG. 18A and FIG. 18B described above. In the case of this system, the unsupervised learner, upon being provided with purchase information of each customer, learns the trends in the purchase information. The trends in the purchase information learned by the learner can be used for classifying the customers into categories.

In order to improve the degree of accuracy of processing, particularly in the case of a system using supervised machine learning, it is necessary to prepare a large number of training data sets for covering various situations and have the learner perform the learning. However, it is troublesome and difficult to prepare a large number of, a variety of training data sets to cover every possible situation.

For this reason, Prior Art Document 2 and Prior Art Document 3 propose a scheme of providing the user with a diagram illustrating a learning model of a support vector machine (SVM). The learning model is obtained by supervised machine learning. According to this scheme, the results of the analysis and the contents of the training data sets are displayed on a two-dimensional plane, so that the user can know the actual way in which the classification is being performed, and can prepare the training data sets efficiently.
Prior Art Document 2: Xiaohong Wang, Sitao Wu, Xiaoru Wang, and Qunzhan Li, “SVMV—A Novel Algorithm for the Visualization of SVM Classification Results”, Advances in Neural Networks—ISNN 2006 Lecture Notes in Computer Science, Volume 3971, 2006, pp 968-973
Prior Art Document 3: “How to Visualize Large Data Sets?”, Advances in Self-Organizing Maps Advances in Intelligent Systems and Computing, Volume 198, 2013, pp 1-12

Prior Art Document 4 discloses a scheme of correcting the data trends learned by a supervised learner, by which the user is provided with the results of classification with respect to representative data sets, so that the user can correct the results not matching the user's decision and can have the learner perform learning again. According to the scheme disclosed in Prior Art Document 4, the user can correct the category labels of the training data sets that the learner already learned, and the user can thereby correct the values expected to be predicted by the learner according to his/her needs. Furthermore, Prior Art Document 5 discloses a scheme of automatically creating training data sets by using a small number of training data sets, and Prior Art Document 6 discloses a scheme of deleting unnecessary training data sets according to the results of learning by a learner.
Prior Art Document 4: JP 2009-070284 A
Prior Art Document 5: JP 2013-125322 A
Prior Art Document 6: JP 2005-181928 A

As stated above, supervised machine learning has a problem: it is troublesome and difficult to prepare a large number of, a variety of training data sets. This problem should be solved while improving the processing accuracy of the system that uses supervised machine learning. Therefore, to solve this problem at its source, it is necessary to allow the user to check the data trends learned by a supervised learner, and at the same time, allows the user to add missing training data sets required for learning.

According to the schemes disclosed in Prior Art Documents 2 and 3, however, although inappropriate training data sets are presented to the user so that the user can delete the inappropriate training data sets, missing training data sets are not presented to the user. It is therefore impossible for the user to add missing training data sets. According to the scheme disclosed in Prior Art Document 4, neither inappropriate training data sets nor missing training data sets are presented to the user, and the user cannot add or delete training data sets. According to the scheme disclosed in Prior Art Document 5, although the user can add training data sets, there is the possibility that the user might create an inappropriate training data set. Furthermore, according to the scheme disclosed in Prior Art Document 6, the user cannot add any new training data set.

As described above, according to the schemes disclosed in Prior Art Documents 2 through 6, the user cannot add missing training data sets required for learning after checking the data trends learned by a supervised learner. In short, the schemes disclosed in Prior Art Documents 2 through 6 cannot solve the aforementioned problem at its source.

### SUMMARY OF THE INVENTION

One example of the objective of the prevent invention is to provide a machine learning apparatus, machine learning method, and non-transitory computer-readable recording medium that are capable of solving the aforementioned problem, and saving the user the trouble of collecting training data sets, while improving the accuracy of processing using supervised machine learning.

To achieve the objective, a machine learning apparatus according to one aspect of the present invention includes: a feature calculation unit that transforms, into first numerical data sets, training data sets to each of which either one of two values is added as a label, each of the first numerical data sets containing a numerical value representing a feature of the corresponding training data set;

a support vector machine learning unit that learns, based on the first numerical data sets obtained by the transformation of the training data sets, and by using a support vector machine, a criterion for classification of the two values in the label, thereby creating a learning model representing the results of the learning;

a self-organizing map learning unit that projects the first numerical data sets onto a two-dimensional map by self-organizing map processing, the two-dimensional map having blocks arranged in a matrix and having representative data sets belonging to the blocks, wherein the self-organizing map learning unit causes, from among the first numerical data sets, two or more first numerical data sets with a short distance from each other to belong to adjacent blocks among the blocks of the two-dimensional map;

a support vector machine classifying unit that classifies, by using the learning model, the blocks of the two-dimensional map, onto which the first numerical data sets have been projected, and the representative data sets; and

a learning model two-dimensionalization unit that creates a two-dimensional learning model representing the results of the classification.

To achieve the objective, a machine learning method according to one aspect of the present invention includes:

(a) a step of transforming, into first numerical data sets, training data sets to each of which either one of two values is added as a label, each of the first numerical data sets containing a numerical value representing a feature of the corresponding training data set;

(b) a step of learning, based on the first numerical data sets obtained by the transformation of the training data sets, and by using a support vector machine, a criterion for classification of the two values in the label, thereby creating a learning model representing the results of the learning;

(c) a step of projecting the first numerical data sets onto a two-dimensional map by self-organizing map processing, the two-dimensional map having blocks arranged in a matrix and having representative data sets belonging to the blocks, wherein the projection is performed such that, from among the first numerical data sets, two or more first numerical data sets with a short distance from each other belong to adjacent blocks or a same block among the blocks of the two-dimensional map;

(d) a step of classifying, by using the learning model created in the step (b), the blocks of the two-dimensional map and the representative data sets; and

(e) a step of creating a two-dimensional learning model representing the results of the classification performed in the step (d).

To achieve the objective, a non-transitory computer-readable recoding medium according to one aspect of the present invention is a non-transitory computer-readable recording medium that stores a program including an instruction for causing a computer to perform:

(a) a step of transforming, into first numerical data sets, training data sets to each of which either one of two values is added as a label, each of the first numerical data sets containing a numerical value representing a feature of the corresponding training data set;

(b) a step of learning, based on the first numerical data sets obtained by the transformation of the training data sets, and by using a support vector machine, a criterion for classification of the two values in the label, thereby creating a learning model representing the results of the learning;

(c) a step of projecting the first numerical data sets onto a two-dimensional map by self-organizing map processing, the two-dimensional map having blocks arranged in a matrix and having representative data sets belonging to the blocks, wherein the projection is performed such that, from among the first numerical data sets, two or more first numerical data sets with a short distance from each other belong to adjacent blocks or a same block among the blocks of the two-dimensional map;

(d) a step of classifying, by using the learning model created in the step (b), the blocks of the two-dimensional map and the representative data sets; and

(e) a step of creating a two-dimensional learning model representing the results of the classification performed in the step (d).

### EFFECTS OF THE INVENTION

As described above, the present invention is capable of saving the user the trouble of collecting training data sets, while improving the accuracy of processing using supervised machine learning.

### BRIEF DESCRIPTION OF THE DRAWINGS

FIG. 1 is a conceptual diagram illustrating processing performed by a conventional support vector machine.

FIG. 2 is a conceptual diagram illustrating a conventional self-organizing map.

FIG. 3 is a diagram illustrating an example of data trends learned according to the present invention.

FIG. 4 is a block diagram illustrating an overall configuration of a machine learning apparatus according to an embodiment of the present invention.

FIG. 5 is a block diagram specifically illustrating the configuration of the machine learning apparatus according to the embodiment of the present invention.

FIG. 6A is a diagram illustrating an example of image training data sets used in the present embodiment, and FIG. 6B is a diagram illustrating an example of image training candidate data sets used in the present embodiment.

FIG. 7A is a diagram illustrating an example of image feature training data sets used in the present embodiment, FIG. 7B is a diagram illustrating an example of image feature training candidate data sets used in the present embodiment, and FIG. 7C is a diagram illustrating an example of SOM representative data sets used in the present embodiment.

FIG. 8A is a diagram illustrating an example of two-dimensional training data sets used in the present embodiment, FIG. 8B is a diagram illustrating an example of two-dimensional training candidate data sets used in the present embodiment, and FIG. 8C is a diagram illustrating an example of a two-dimensional learning model used in the present embodiment.

FIG. 9 is a diagram illustrating an example of synthesized two-dimensional data sets used in the present embodiment.

FIG. 10 is a flowchart illustrating operation of a machine learning apparatus according to the embodiment of the present invention.

FIG. 11 is a schematic diagram illustrating the phases of operation performed in the embodiment of the present invention.

FIG. 12 is a diagram illustrating images before and after application of a Gabor filter.

FIG. 13 is a diagram illustrating an example of synthesized two-dimensional data sets visualized in the embodiment of the present invention.

FIG. 14 is a diagram illustrating an example of a case where the synthesized two-dimensional data sets illustrated in FIG. 13 require correction, deletion, or addition of image training data sets.

FIG. 15 is a block diagram illustrating an example of a computer that implements a machine learning apparatus according to the embodiment of the present invention.

FIGS. 16A and 16B are diagrams illustrating usage example 1 of a system implementing a conventional machine learning scheme.

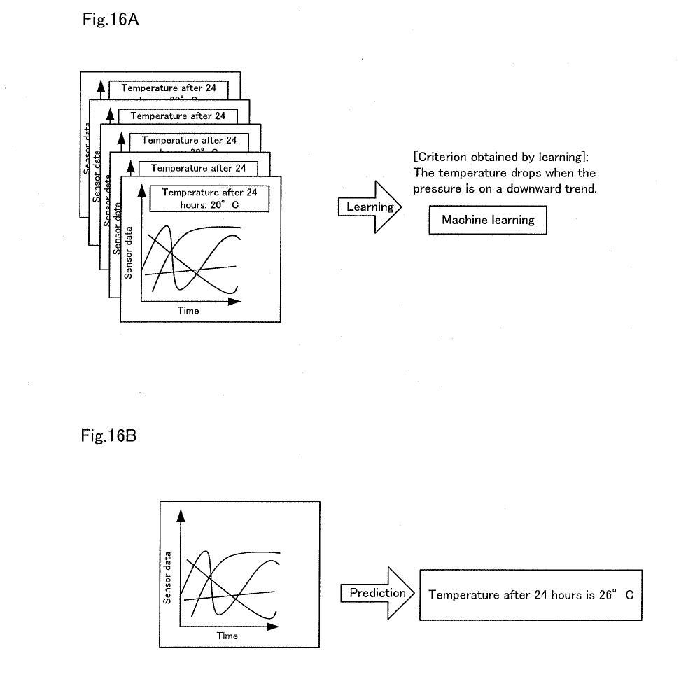

FIGS. 17A and 17B are diagrams illustrating usage example 2 of a system implementing a conventional machine learning scheme.

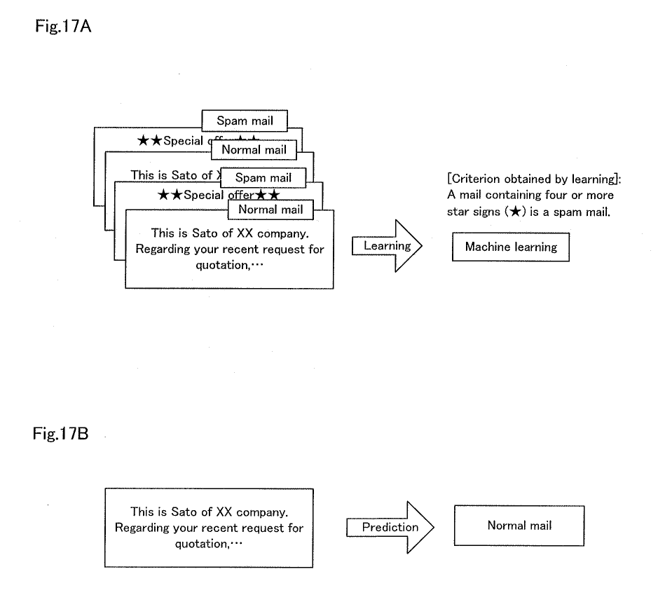

FIGS. 18A and 18B are diagrams illustrating usage example 3 of a system implementing a conventional machine learning scheme.

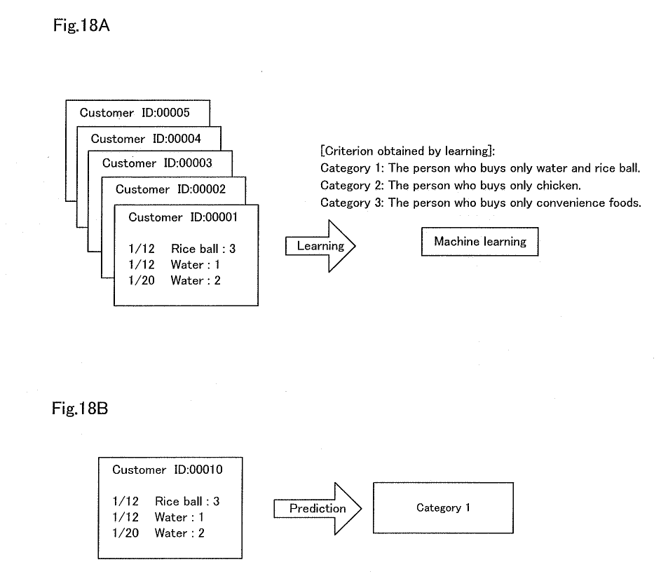

### EXEMPLARY EMBODIMENT

### Summary of the Invention

A primary feature of the present invention is to combine a self-organizing map (SOM), which is used for an unsupervised machine learning scheme, with a support vector machine (SVM), which is used for a supervised machine learning scheme.

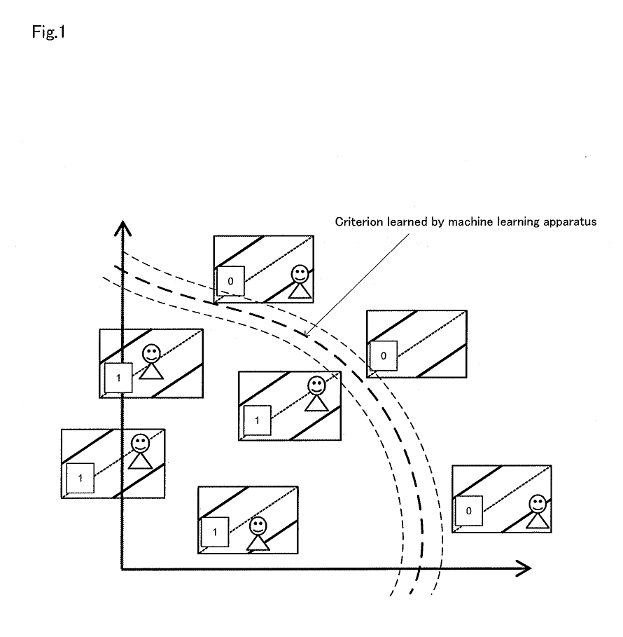

An SVM uses training data sets, and learns basically the criterion for classifying data sets into two classes (see Reference Document 1 below). As shown in FIG. 1, an SVM learns a classification boundary that maximizes the distance between the two classes of data sets. FIG. 1 is a conceptual diagram illustrating processing performed by a conventional support vector machine. The SVM can transform data sets having complicated classification boundaries so as to simplify the criterion for classification. Furthermore, in order to create a simple criterion for classification, the SVM uses kernel functions for transforming data sets so that the data sets can be represented in a high-dimensional space.

An SOM is a sort of neural network model representing the cranial nerve system, and is used for a machine learning scheme. An SOM can project high-dimensional data sets onto a two-dimensional map with the distances between the data sets being maintained, without using training data sets (see Reference Document 2 below). The present invention uses an SOM in order for two-dimensional representation of the high-dimensional data sets and of the criterion for an SVM.

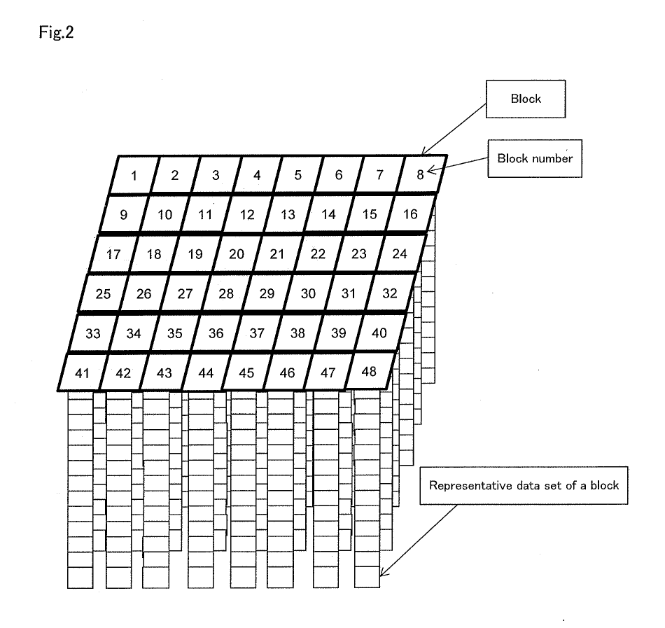

As shown in FIG. 2, an SOM is composed of blocks arranged in a matrix and representative data sets belonging to each block. FIG. 2 is a conceptual diagram illustrating a conventional self-organizing map. When data sets are input to the SOM shown in FIG. 2, the data trends are analyzed. According to the results of the analysis, all or some of the input data sets are considered as representative data sets belonging to any of the blocks of the two-dimensional map, and are projected onto the two-dimensional map.

At this stage, two or more data sets that are at a short distance from each other (i.e., similar to each other) are reckoned to belong to blocks that are at a short distance from each other, and two or more data sets that are at a long distance from each other (i.e., not similar to each other) are reckoned to belong to blocks that are at a long distance from each other. Since each block of the SOM is located on a two-dimensional plane, the data sets can be projected onto the two-dimensional map by assuming the blocks to be two-dimensional coordinates.

In the SOM, the distance between data sets may be defined in any manner insofar as the calculation of the distance between two data sets is possible. For example, the Euclidean distance, the sinusoidal distance, or the Manhattan distance may be used. Note that when, for example, the SVM classifies images by using a kernel function serving as a distance function, the distance used in the SOM may be defined by a kernel function.

Another feature of the present invention is to make estimation of missing training data sets easier by using data trends that are represented two-dimensionally. On a two-dimensional map, with respect to the blocks not having a sufficient number of training data sets, i.e., low-density blocks of the two-dimensional map, data sets without a category label are extracted and presented to the user, so that the user can easily add missing training data sets.

Yet another feature of the present invention is to detect training data sets that have been given a possibly incorrect category label by the user, by using data trends that are represented two-dimensionally. This feature makes it easy for the user to correct or delete training data sets.

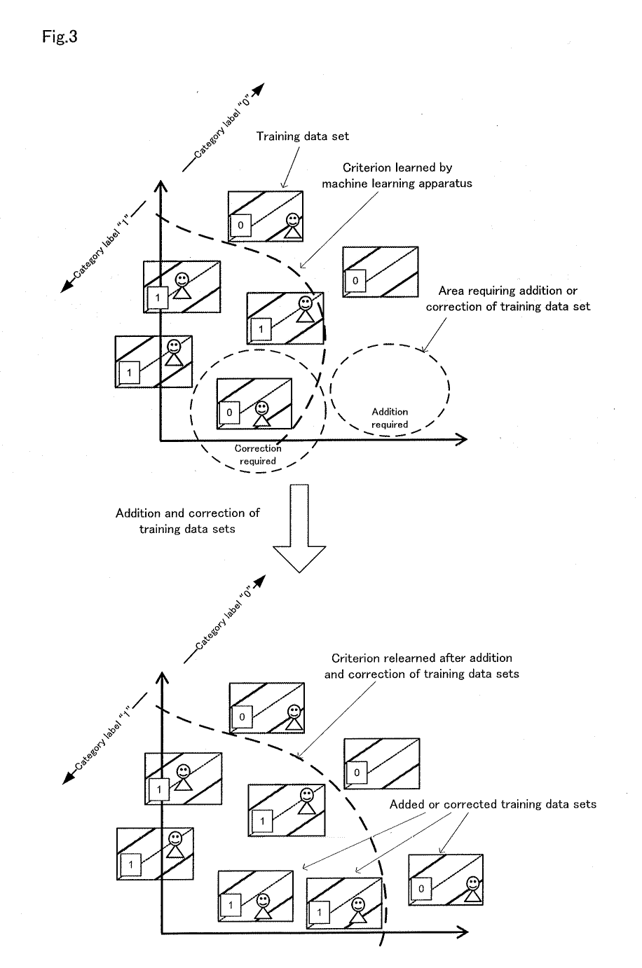

Specifically, as shown in FIG. 3 for example, the above feature makes it possible to represent the data trends learned by the learner, in the form of a curved line on a two-dimensional coordinate plane. This feature allows the user to visually check the blocks not having a sufficient number of training data sets, and add images existing in the blocks to the training data sets. FIG. 3 is a diagram illustrating an example of trends in learned data sets according to the present invention.

Since the user can thus check the data trends learned by the learner, the user can correct or delete inappropriate training data sets, which may degrade the calcification accuracy. Note that inappropriate training data sets include, for example, a training data set for which it is difficult even for the user to determine the category, and a training data set to which the user has added an incorrect category label. As described above, since this feature allows the user to check the data trends learned by the learner, the user only needs to perform addition, correction, or deletion with respect to training data sets. Therefore, this feature makes it possible to prepare training data sets more efficiently.

Note that it is impossible for conventional technologies to display a graphical representation, as shown in FIG. 3, of the data trends learned by a learner so that the user can check the trends. This is because the data trends learned by a learner are extremely high-dimensional numerical values. Without using the present invention, it is impossible to represent the trends in the form of values on a two-dimensional coordinate plane, which is easy to understand for the user. For this reason, conventional technologies require the user to create a large number of training data sets, give the data sets to the learner to have it learn the data sets, and if the accuracy of detection by the learner is not satisfactory, then create a large number of training data sets again in order to improve the detection accuracy. Conventionally, it has been extremely difficult to efficiently prepare a large number of training data sets.

### Embodiment

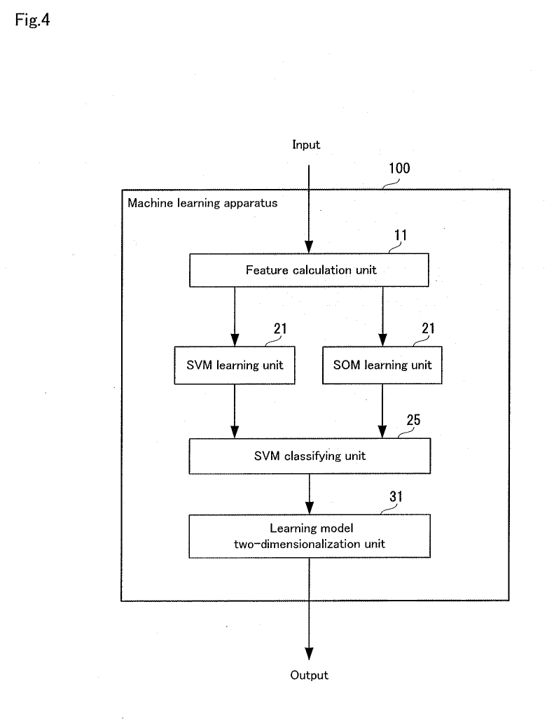

The following describes a machine learning apparatus, machine learning method, and computer program according to an embodiment of the present invention, with reference to FIGS. 4 through 15.

### [Configuration of Apparatus]

First, the configuration of a machine learning apparatus according to the embodiment of the present invention is described with reference to FIG. 4. FIG. 4 is a block diagram illustrating an overall configuration of a machine learning apparatus according to the embodiment of the present invention.

A machine learning apparatus 100 according to the present embodiment shown in FIG. 4 is constructed by combining a self-organizing map with a support vector machine. As shown in FIG. 4, the machine learning apparatus 100 includes a feature calculation unit 11, a support vector machine learning unit 21, a self-organizing map learning unit 22, a support vector machine classifying unit 25, and a learning model two-dimensionalization unit 31. In the following, a support vector machine is denoted as “SVM”, and a self-organizing map is denoted as “SOM”.

The feature calculation unit 11 transforms, into first numerical data sets, training data sets to each of which either one of two values is added as a label, each of the first numerical data sets containing a numerical value representing a feature of the corresponding training data set. The SVM learning unit 21 learns, based on the first numerical data sets obtained by the transformation of the training data sets, and by using a SVM, a criterion for classification of the two values in the label, thereby creating a learning model representing the results of the learning.

The SOM learning unit 22 projects the first numerical data sets onto a two-dimensional map by SOM processing, the two-dimensional map having blocks arranged in a matrix and having representative data sets belonging to the blocks. In this regard, the SOM learning unit 22 causes, from among the first numerical data sets, two or more first numerical data sets with a short distance from each other to belong to adjacent blocks among the blocks of the two-dimensional map.

The SVM classifying unit 25 classifies, by using the learning model created by the SVM learning unit 21, the blocks of the two-dimensional map and the representative data sets. The learning model two-dimensionalization unit 31 creates a two-dimensional learning model representing the results of the classification.

As described above, the machine learning apparatus 100 according to the present embodiment allows the user to check the data trends learned by the learner by using the two-dimensional learning model, so that the user can easily find training data sets to be corrected, training data sets to be deleted, and training data sets to be added. Consequently, the machine learning apparatus 100 is capable of saving the user the trouble of collecting training data sets, while improving the accuracy of processing using supervised machine learning.

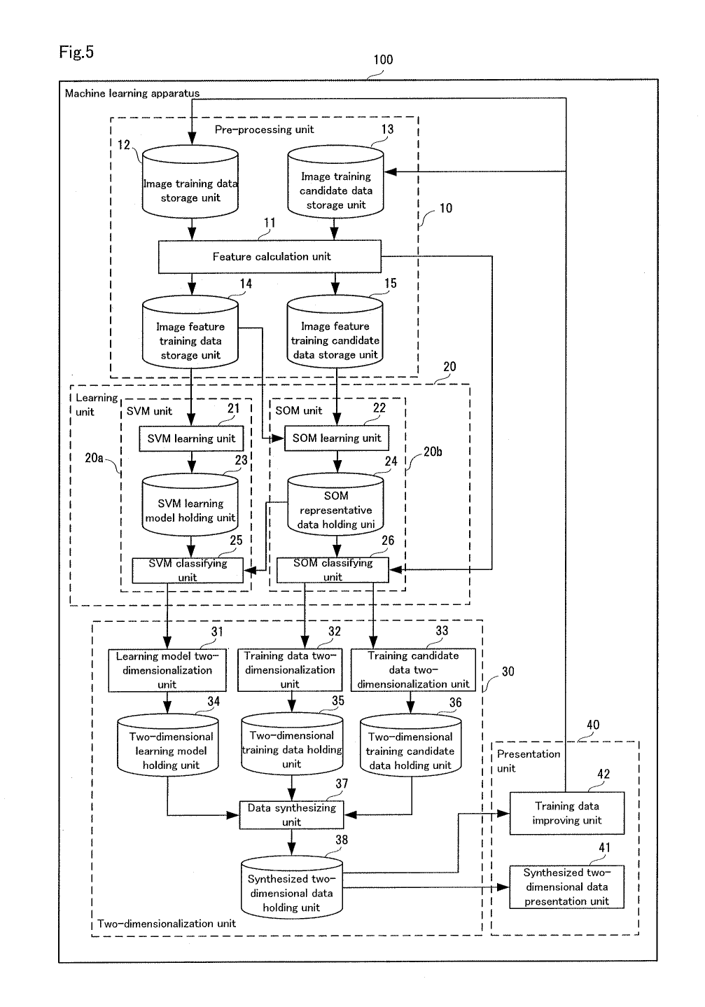

Next, the configuration of the machine learning apparatus according to the embodiment of the present invention is more specifically described with reference to FIG. 5 through FIG. 9. FIG. 5 is a block diagram specifically illustrating the configuration of the machine learning apparatus according to the embodiment of the present invention.

In the following description, suppose that the training data sets are image data sets to each of which a category label “0” or “1” has been added by the user. Also note that a training data set created by adding a category label to an image data set is hereinafter denoted as “image training data set”.

As shown in FIG. 5, the machine learning apparatus 100 according to the present embodiment includes primarily a pre-processing unit 10, a learning unit 20, a two-dimensionalization unit 30, and a presentation unit 40. The following specifically explains each of the units.

As shown in FIG. 5, the pre-processing unit 10 includes a feature calculation unit 11, an image training data storage unit 12, an image training candidate data storage unit 13, an image feature training data storage unit 14, and an image feature training candidate data storage unit 15. With this structure, the pre-processing unit 10 transforms the image training data sets and image training candidate data sets into numerical data sets that are usable for learning with the aid of the support vector machine and the self-organizing map.

The image training data storage unit 12 stores image training data sets each created by the user adding a category label “0” or “1” to an image data set. Since the category labels of the image training data sets are manually added by the user, some of the category labels could be inappropriate. As described below, according to the present embodiment, image training data sets that are inappropriate for learning by the SVM are presented to the user from among the image training data sets stored in the image training data storage unit 12, thereby encouraging the user to correct or delete the inappropriate image training data sets.

The image training candidate data storage unit 13 stores image training candidate data sets, which are image data sets to which no category label has been added by the user. Although all the image data sets should ideally be turned into image training data sets, this is not feasible when there are a large number of image data sets. For this reason, in order to supplement the image training data sets required for the learning by the SVM, the present embodiment provides the user with the image training candidate data sets, thereby encouraging the user to add a category label to them.

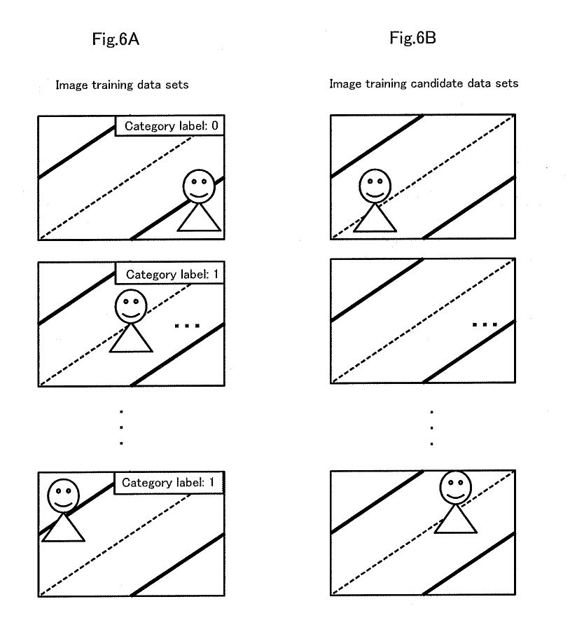

Here, a description is given to a specific example of image training data sets and image training candidate data sets, with reference to FIGS. 6A and 6B. FIG. 6A is a diagram illustrating an example of image training data sets used in the present embodiment, and FIG. 6B is a diagram illustrating an example of image training candidate data sets used in the present embodiment.

The image data sets shown in FIGS. 6A and 6B are data sets used for determination by an intrusion detection system. As shown in FIG. 6A, each image training data set has either category label “1”, which indicates intrusion, or category label “0”, which indicates absence of intrusion. On the other hand, as shown in FIG. 6B, none of the image training candidate data sets has a category label.

As described above, the feature calculation unit 11 transforms the image training data sets (see FIG. 6A) stored in the image training data storage unit 12 into the first numerical data sets (hereinafter, “image feature training data sets”) that the SVM and the SOM can learn. The feature calculation unit 11 also transforms the image training candidate data sets (see FIG. 6B) stored in the image training candidate data storage unit 13 into the second numerical data sets (hereinafter, “image feature training candidate data sets”.

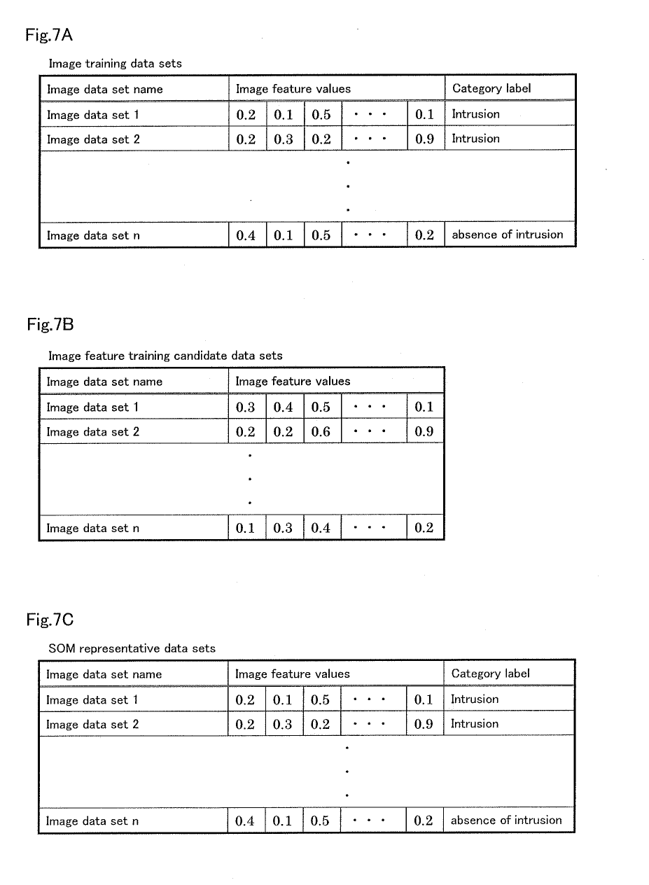

The image feature training data storage unit 14 stores the image feature training data sets obtained by the transformation performed by the feature calculation unit 11. The image feature training candidate data storage unit 15 stores the image feature training candidate data sets obtained by the transformation performed by the feature calculation unit 11. Note that a description of a specific example of the image feature training data sets and the image feature training candidate data sets is provided below with reference to FIGS. 7A through 7C.

As shown in FIG. 5, the learning unit 20 includes an SVM unit 20a and an SOM unit 20b. With this configuration, the learning unit learns the SVM and the SOM by using the image feature training data sets stored by the pre-processing unit 10. The learning unit 20 also classifies, by using the learned SVM, SOM representative data sets, which are described later, and furthermore, by using the SOM representative data sets after the classification (see FIG. 7C described below), classifies the image feature training data sets and the image feature training candidate data sets.

The SVM unit 20a includes an SVM learning unit 21, an SVM learning model holding unit 23, and an SVM classifying unit 25. The SVM unit 20a learns the classification criterion for classification between the categories “0” and “1” by using the image feature training data sets stored in the image feature training data storage unit 14 (see FIG. 7A described below), and classifies the image training data sets (FIG. 6A).

In the present embodiment, the SVM learning unit 21 receives the image feature training data sets stored in the image feature training data storage unit 14, and, by using the SVM, learns the criterion for classification between the categories “0” and “1”. As the results of the learning, the SVM learning unit 21 outputs an SVM learning model. Note that the SVM learning model represents the classification criterion learned by the SVM.

The SVM learning model holding unit 23 holds the criterion for classification between the categories “0” and “1”, which is the SVM learning model, output by the SVM learning unit 21. The SVM learning model is used for classification of category labels to be added to the SOM representative data sets, which are described below.

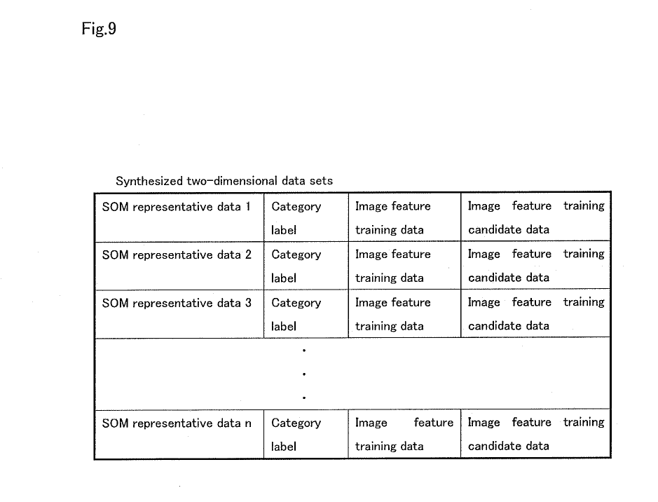

In the present embodiment, the SVM classifying unit 25 classifies the SOM representative data sets described below (see FIG. 7C described below) into the category “0” or “1” by using the SVM learning model held by the SVM learning model holding unit 23. According to the present invention, the SVM learning model is used for classifying the SOM representative data sets (see FIG. 9).

The SOM unit 20b includes an SOM learning unit 22, an SOM representative data holding unit 24, and an SOM classifying unit 26. The SOM unit 20a calculates the SOM representative data sets (see FIG. 7C described later). The SOM representative data sets are used for transforming the image feature training data sets (see FIG. 7A described below) and the image feature training candidate data sets (see FIG. 7B described below) into two-dimensional data sets. In order to specify the blocks that the data sets belong to, the SOM unit 20a visualizes the criterion for the SVM, the image training data sets, and the image training candidate data sets.

In the present embodiment, the SOM learning unit 22 performs SOM processing to project the image feature training data sets in the image feature training data storage unit 14 onto a two-dimensional map composed of blocks arranged in a matrix and representative data sets each belonging to one of the blocks, thereby learning the SOM. After learning the SOM, the SOM learning unit 22 creates SOM representative data sets from the two-dimensional map onto which the image feature training data sets have been projected.

The SOM representative data holding unit 24 holds the SOM representative data sets output by the SOM learning unit 22. The SOM representative data sets are used for specifying the blocks that the data sets belong to on the two-dimensional map, with respect to each of the image feature training data sets stored in the image feature training data storage unit 14 and each of the image feature training candidate data sets stored in the image feature training candidate data storage unit 15.

The SOM classifying unit 26 specifies, on the two-dimensional map, the blocks that correspond to the image feature training data sets, by using the SOM representative data sets. Specifically, the SOM classifying unit 26 calculates the SOM representative data set that is at the shortest distance from the image feature training data set, and specifies the block that the SOM representative data set so calculated belongs to. Similarly, the SOM classifying unit 26 also specifies the blocks that the image feature training candidate data sets belong, by using the SOM representative data sets.

The following explains a specific example of the image feature training data sets, the image feature training candidate data sets, and the SOM representative data sets, with reference to FIG. 7. FIG. 7A is a diagram illustrating an example of the image feature training data sets used in the present embodiment, FIG. 7B is a diagram illustrating an example of the image feature training candidate data sets used in the present embodiment, and FIG. 7C is a diagram illustrating an example of the SOM representative data sets used in the present embodiment.

As shown in FIG. 7A, each image feature training data set is a numerical sequence composed of image feature values and a category label of the corresponding image data set. As shown in FIG. 7B, each image feature training data set is a numerical sequence composed only of image feature values of the corresponding image data set. As shown in FIG. 7C, each SOM representative data set is a numerical sequence composed of representative data for the corresponding block of the two-dimensional map. In the example shown in FIG. 7C, each SOM representative data set is composed of the image feature values of the image feature training data set projected onto the corresponding block of the two-dimensional map. Therefore, when there are a plurality of image feature training data sets having the same image feature values, these image feature training data sets belong to the same block.

As shown in FIG. 5, the two-dimensionalization unit 30 includes a learning model two-dimensionalization unit 31, a training data two-dimensionalization unit 32, a training candidate data two-dimensionalization unit 33, a two-dimensional learning model holding unit 34, a two-dimensional training data holding unit 35, a two-dimensional training candidate data holding unit 36, a data synthesizing unit 37, and a synthesized two-dimensional data holding unit 38.

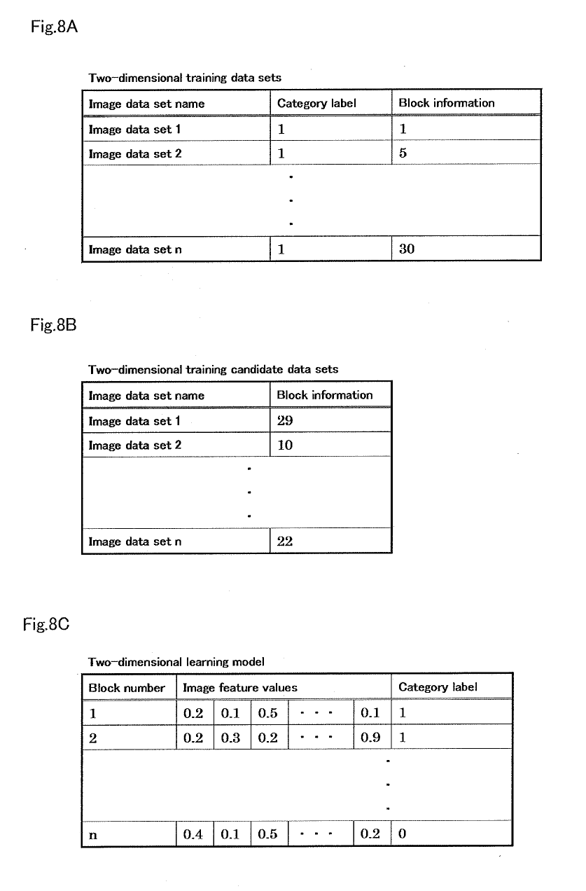

As described above, the learning model two-dimensionalization unit 31 creates a two-dimensional learning model, which indicates the results of the classification performed by the SVM classifying unit 25. Specifically, the learning model two-dimensionalization unit 31 creates a two-dimensional criterion from the criterion obtained by the SVM classifying unit 25 for classification between the categories “0” and “1”, and thus creates a two-dimensional learning model (see FIG. 8C described below).

The training data two-dimensionalization unit 32 creates two-dimensional training data sets (see FIG. 8A described below) by associating each of the image feature training data sets with the block specified by the SOM classifying unit 26. The two-dimensional training data sets so created are held by the two-dimensional training data holding unit 35.

The training candidate data two-dimensionalization unit 33 creates two-dimensional training candidate data sets (see FIG. 8B described below) by associating each of the image feature training candidate data sets with the block specified by the SOM classifying unit 26. The two-dimensional training candidate data sets so created are held by the two-dimensional training candidate data holding unit 36.

The two-dimensional learning model holding unit 34 holds the two-dimensional learning model (see FIG. 8C described below) created by the learning model two-dimensionalization unit 31. The two-dimensional training data holding unit 35 holds the two-dimensional training data sets (see FIG. 8A described below) created by the training data two-dimensionalization unit 32. The two-dimensional training candidate data holding unit 36 holds the two-dimensional training candidate data sets (see FIG. 8B described below) created by the training candidate data two-dimensionalization unit 33.

The data synthesizing unit 37 creates synthesized two-dimensional data sets (see FIG. 9 described below) by combining the two-dimensional training data sets and the two-dimensional training candidate data sets with the two-dimensional learning model. The synthesized two-dimensional data sets created by the data synthesizing unit 37 are held by the synthesized two-dimensional data holding unit 38.

The synthesized two-dimensional data sets are used by a synthesized two-dimensional data presentation unit 41, which is described below, to present on the screen the two-dimensional learning model, the image training data sets that may be corrected or deleted, and image training candidate data sets that may be added.

Here, a description is given to the two-dimensional training data sets, the two-dimensional training candidate data sets, and the two-dimensional learning model with reference to FIGS. 8A through 8C, and a description is given to the synthesized two-dimensional data sets with reference to FIG. 9. FIG. 8A is a diagram illustrating an example of the two-dimensional training data sets used in the present embodiment, FIG. 8B is a diagram illustrating an example of the two-dimensional training candidate data sets used in the present embodiment, and FIG. 8C is a diagram illustrating an example of the two-dimensional learning model used in the present embodiment. FIG. 9 is a diagram illustrating an example of the synthesized two-dimensional data sets used in the present embodiment.

As shown in FIG. 8A, each two-dimensional training data set corresponds to one of the image training data sets, and is composed of the name of the image data set, the category label, and the information of the block that the corresponding image training data belongs to. As shown in FIG. 8B, each two-dimensional training candidate data set corresponds to one of the image training candidate data sets, and is composed of the name of the image data set and the information of the block that the image data set belongs to. As shown in FIG. 8C, each item of the two-dimensional learning model is composed of the representative data sets and the category label of the corresponding block. As shown in FIG. 9, each synthesized two-dimensional data set corresponds to one of the SOM representative data sets, and is composed of the category label, the name of the image feature training data belonging to the corresponding block, and the name of the image feature training candidate data belonging to the corresponding block.

As shown in FIG. 5, the presentation unit 40 includes a synthesized two-dimensional data presentation unit 41 and a training data improving unit 42. With this configuration, the presentation unit 40 is capable of visualizing the SVM learning model created from the image training data sets, the image training data sets, and the image training candidate data sets, thereby encouraging the user to correct, delete, or add image training data sets.

The synthesized two-dimensional data presentation unit 41 visualizes, thereby providing the user with the learning status of the SVM based on the synthesized two-dimensional data sets (see FIG. 9). Specifically, the synthesized two-dimensional data presentation unit 41 displays, on the screen, the blocks of the two-dimensional learning model (see FIG. 8C) based on the synthesized two-dimensional data sets. The synthesized two-dimensional data presentation unit 41 also displays, for each block, the results of the classification, the number of the image feature training data sets associated with the block, and the respective labels of the image feature training data sets associated with the block.

When any of the blocks being displayed is selected, the synthesized two-dimensional data presentation unit 41 specifies the image feature training data sets and the image feature training candidate data sets that are associated with the selected block. Then, the synthesized two-dimensional data presentation unit 41 displays, on the screen, the original training data sets from which the specified image feature training data sets have been created by transformation, and the original training candidate data sets from which the specified image feature training candidate data sets have been created by transformation.

The training data improving unit 42 compares the image feature training data sets that are associated with a target block, with the image feature training data sets that are associated with blocks located around the target block. Based on the results of the comparison, the training data improving unit 42 shows an instruction on the screen to encourage the user to delete, or correct the label of, the original image training data sets from which the image feature training data sets associated with the target block have been created by transformation.

When the number of image feature training data sets associated with the target block is no greater than a threshold value, the training data improving unit 42 displays, on the screen, the original image training candidate data sets from which the image feature training candidate data sets associated with the target block have been created by transformation. Finally, the training data improving unit 42 instructs the user to add the image training candidate data sets, which are displayed on the screen, to the image training data sets.

### [Operation of Apparatus]

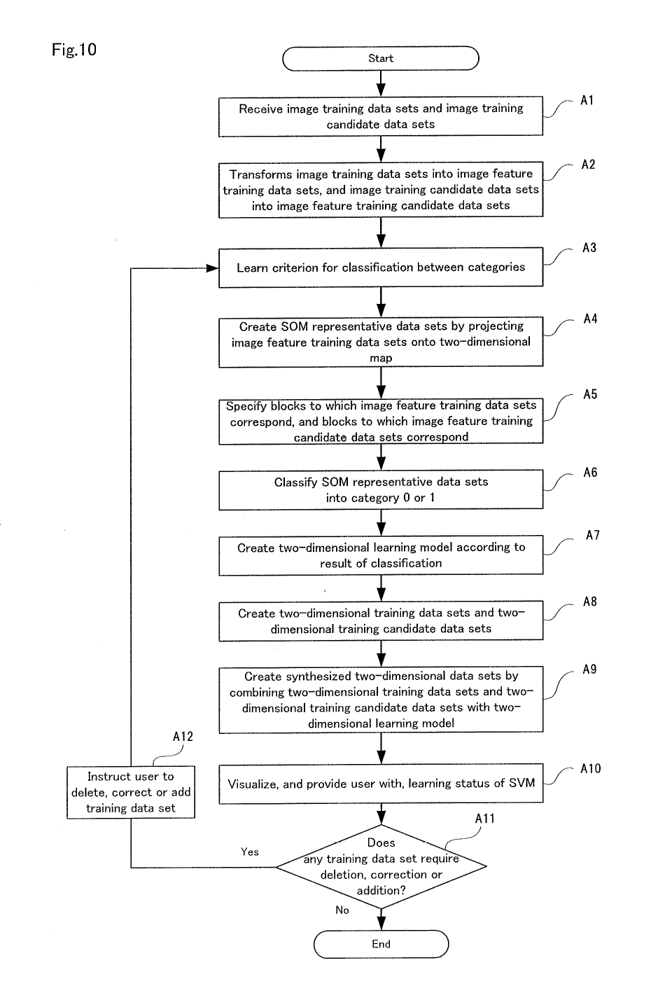

The following describes operation of the machine learning apparatus 100 according to the embodiment of the present invention, with reference to FIG. 10. FIG. 10 is a flowchart illustrating operation of a machine learning apparatus according to the embodiment of the present invention. In the following description, FIG. 4 through FIG. 9 are referred to where appropriate. In the present embodiment, the machine learning apparatus 100 operates according to a machine learning method. Therefore, the following explanation of the operation of the machine learning apparatus 100 also serve as explanation of the machine learning method according to the present embodiment.

First, as a precondition, the user prepares a large number of image data sets, adds a category label “0” or “1” to some of the image data sets according to his/her own judgment, and determines the image data sets, to which either category label has been added, to be image training data sets. Also, the user determines the rest of the image data sets, to which no category label has been added, to be image training candidate data sets. The user inputs the image training data sets and the image training candidate data sets into the machine learning apparatus 100 by using a terminal apparatus or the like.

As shown in FIG. 10, upon receiving the image training data sets and the image training candidate data sets, the machine learning apparatus 100 stores the image training data sets into the image training data storage unit 12, and stores the image training candidate data sets into the image training candidate data storage unit 13 (Step A1).

Next, the feature calculation unit 11 transforms the image training data sets in the image training data storage unit 12 into image feature training data sets, and transforms the image training candidate data sets in the image training candidate data storage unit 13 into image feature training candidate data sets (Step A2). The feature calculation unit 11 also stores the image feature training data sets into the image feature training data storage unit 14, and stores the image feature training candidate data sets into the image feature training candidate data storage unit 15.

Next, the SVM learning unit 21 receives the image feature training data sets stored in the image feature training data storage unit 14, and, by using the SVM, learns the criterion for classification between the categories “0” and “1” (Step A3). The criterion for classification between the categories “0” and “1” output by the SVM learning unit 21, namely an SVM learning model, is held by the SVM learning model holding unit 23.

Next, the SOM learning unit 22 performs SOM processing to project the image feature training data sets in the image feature training data storage unit 14 onto a two-dimensional map composed of blocks arranged in a matrix and representative data sets each belonging to one of the blocks, thereby learning the SOM (Step A4).

The SOM learning unit 22 creates SOM representative data sets from the two-dimensional map, and outputs them to the SOM representative data sets holding unit 24 so that the SOM representative data sets holding unit 24 holds the SOM representative data sets.

Next, by using the SOM representative data sets, the SOM classifying unit 26 specifies the blocks of the two-dimensional map to which the image feature training data sets correspond, and the blocks of the two-dimensional map to which the image feature training candidate data sets correspond (Step A5).

Next, by using the SVM learning model held by the SVM learning model holding unit 23, the SVM classifying unit 25 classifies the SOM representative data sets created at Step A4 into the category “0” or “1” (Step A6).

Next, the learning model two-dimensionalization unit 31 creates a two-dimensional learning model that represents the results of the classification at Step A6 (Step A7). The two-dimensional learning model (see FIG. 8C) so created is held by the learning model two-dimensionalization unit 31.

Next, the training data two-dimensionalization unit 32 creates two-dimensional training data sets by associating the image training data sets and the corresponding blocks specified at Step A5 (Step A8). Also at Step A8, the training candidate data two-dimensionalization unit 33 creates two-dimensional training candidate data sets by associating the image feature training candidate data sets and the corresponding blocks specified at Step A5. The two-dimensional training data sets are held by the two-dimensional training data holding unit 35, and the two-dimensional training candidate data sets are held by the two-dimensional training candidate data holding unit 36.

Next, the data synthesizing unit 37 creates synthesized two-dimensional data sets (see FIG. 9) by combining the two-dimensional training data sets and the two-dimensional training candidate data sets with the two-dimensional learning model (Step A9).

Next, the synthesized two-dimensional data presentation unit 41 visualizes, thereby providing the user with, the learning status of the SVM based on the synthesized two-dimensional data sets (FIG. 9) (Step A10). Specifically, the synthesized two-dimensional data presentation unit 41 displays, on the screen, the blocks of the two-dimensional learning model (see FIG. 8C).

Next, the training data improving unit 42 determines whether or not the training data sets require deletion, correction or addition (Step A11). If it is determined at Step A11 that the training data sets do not require deletion, correction nor addition, the processing performed by the machine learning apparatus 100 ends.

On the other hand, if it is determined at Step A11 that the training data sets require deletion, correction or addition, the training data improving unit 42 displays an instruction on the screen and encourages the user to follow the instruction (Step A12). When the user makes deletion, correction, or addition the training data sets after Step A12, Step A3 is performed again.

After that, according to the present embodiment, an image classification system that is applicable to an intrusion detection system is established by using the SVM learning model eventually obtained.

Generally, in order to improve the accuracy of category classification by an image classification system, it is necessary to prepare a large number of image training data sets by adding a category label to images corresponding to various situations, not a single situation, and to have the learner learn the training data sets. However, it is troublesome to collect images corresponding to every possible situation and prepare a large number of image training data sets.

In contrast, when using the machine learning apparatus according to the present embodiment, the user can check the data trends learned by the SVM and can selectively add only missing training data sets required for learning, which reduces the amount of work for preparing the training data sets. Furthermore, the machine learning apparatus also allows the user to correct or delete inappropriate training data sets, which may degrade the calcification accuracy. Note that inappropriate training data sets include, for example, a training data set for which it is difficult even for the user to determine the category, and a training data set to which the user has added an incorrect category label.

### Specific Examples

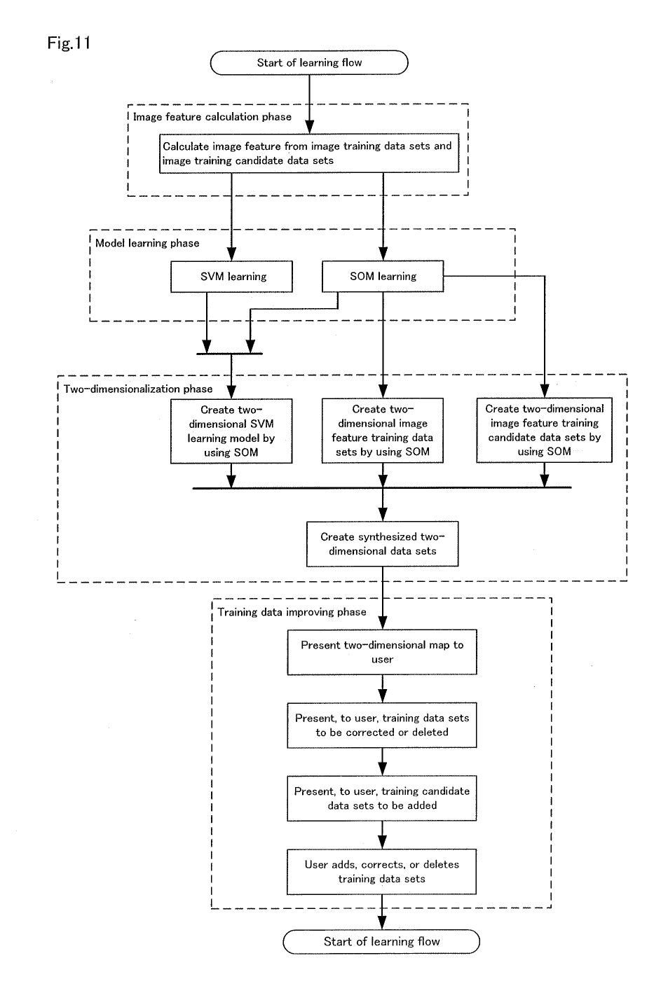

The following describes a specific example of the present embodiment, with reference to FIGS. 11 through 15. Note that the following description also refers to FIG. 1 through FIG. 10 where appropriate. FIG. 11 is a schematic diagram illustrating the phases of operation performed in the embodiment of the present invention.

First, as a precondition, suppose that the user has input the image training data sets and image training candidate data sets, and they are stored in the image training data storage unit 12 and the image training candidate data storage unit 13, respectively. After that, as shown in FIG. 11, an image feature calculation phase, a model learning phase, a two-dimensionalization phase, and a training data improving phase are performed.

### Image Feature Calculation Phase:

In the image feature calculation phase, image feature values are calculated from each of the image training data sets and the image training candidate data sets. Specifically, the feature calculation unit 11 calculates an image feature value from each of the image training data sets and the image training candidate data sets, and transforms each data set into a single numerical sequence.

In addition, the feature calculation unit 11 stores the image feature training data sets, which have been obtained by transformation of the image training data sets into the image feature values, into the image feature training data storage unit 14. Furthermore, the feature calculation unit 11 stores the image feature training candidate data sets, which have been obtained by transformation of the image training candidate data sets into the image feature values, into the image feature training candidate data storage unit 15.

The method of calculating the image feature values used in the present embodiment is not limited to any particular methods insofar as the images can be transformed into numerical sequences. Specific examples of the method of calculating the image feature value includes SHIFT method (see Reference Document 3 described below), HOG method (see Reference Document 3 described below), and Gabor method (see Reference Document 4 described below).

For example, when calculating the image feature value by the Gabor method, first, the feature calculation unit 11 applies a Gabor filter to each image to transform the image into a monochrome image.

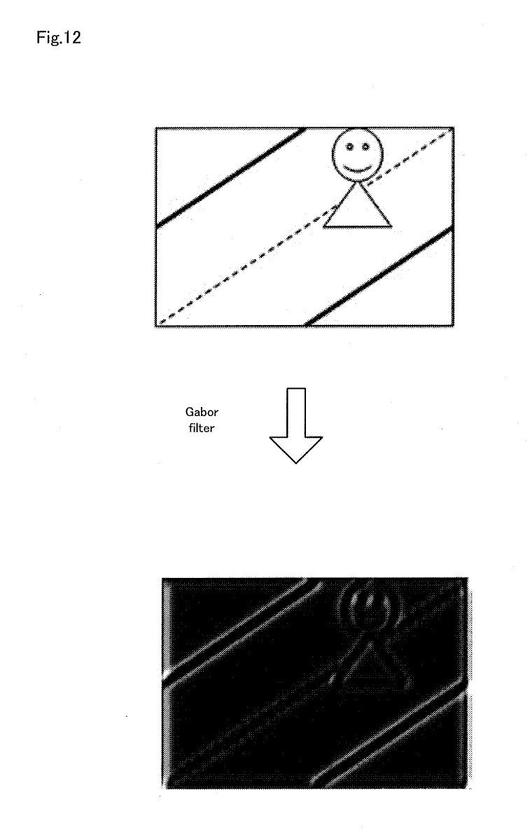

As shown in FIG. 12, in the image that the Gabor filter is applied to, lines extending in a particular direction stand out in white. FIG. 12 is a diagram illustrating images before and after application of the Gabor filter.

Next, the feature calculation unit 11 equally divides into blocks the image that the Gabor filter has been applied to, and calculates the proportion of the pixel value in each of the block. The feature calculation unit 11 then arranges the proportions of the respective pixel values of the blocks to form a numerical sequence, and determines the numerical sequence to be the image feature values of the image. The feature calculation unit 11 also creates an image feature training data set by adding the name of the original image training data set and the category label to the image feature values. When the original data set does not have a category label, the feature calculation unit 11 adds the name of the original training candidate data set to the image feature values, thereby creating an image feature training candidate data set.

The image feature training data sets and the image feature training candidate data sets calculated in the image feature calculation phase are used in the subsequent phase, which is the model learning phase, in order to create the SVM and SOM learning models.

### Model Learning Phase:

The SVM learning unit 21 receives the image feature training data sets, and creates, by using the repetitive learning method discussed in Reference Document 1 described below, an SVM learning model, which serves as a criterion for classification between the categories “0” and “1”. The SVM learning unit 21 stores the SVM learning model into the SVM learning model holding unit 23. The SVM learning model is, specifically, a parameter value representing the classification boundary between the two categories classified by the SVM.

The SOM learning unit 22 receives the image feature training data sets, creates the SOM representative data sets (see FIG. 7C), and stores the SOM representative data sets into the SOM representative data holding unit 24. In explanation of an SOM, calculating the SOM representative data sets from the training data sets is referred to as “learning”.

Since an SOM is for an unsupervised machine learning scheme, the category labels “1” or “0” attached to the image training data sets are unnecessary. In the present embodiment, the kernel function used in the SVM is also used for defining the distances between the data sets in the SOM. Examples of the kernel function include a polynomial kernel (see Reference Document 1 described below), and a Gaussian kernel (see Reference Document 1 described below). The SOM representative data sets can be created by using the method disclosed in Reference Document 5 described below.

In the present embodiment, as shown in FIG. 7C, each SOM representative data set is a numerical sequence composed of the representative data set of the corresponding one of the blocks arranged in a matrix (see FIG. 2), and the block number identifying the block. The representative data set of each block is a numerical sequence having the same number of elements as the image feature values.

Upon completion of the learning in the SVM and the SOM, in the subsequent phase, namely the two-dimensionalization phase, the SVM learning model, the image feature training data sets, and the image feature training candidate data sets are transformed to be two-dimensional, based on the SOM representative data sets.

### Two-Dimensionalization Phase:

In the two-dimensionalization phase, the two-dimensionalization unit 30 creates a two-dimensional model from the SVM learning model by using the SOM. The learning model two-dimensionalization unit 31 classifies the SOM representative data sets by using the SVM learning model. Examples of the method of classifying data sets by using the SVM include the scheme disclosed in the Reference Document 1 described below.

By classifying the blocks corresponding to the SOM representative data sets (see FIG. 7C) by using the SVM, it is possible to know the category, “0” or “1”, that each of the blocks of the SOM arranged in a matrix (See FIG. 2) belongs to. The blocks of the SOM constitute a two-dimensional plane according to the definition of the distance used for classification by the SVM of the data sets. Since the metric space defined for the data sets on the SOM is the same as the metric space for the SVM, the classification criterion learned by the SVM can be transformed into a two-dimensional criterion by classifying the SOM representative data sets by using the SVM.

The learning model two-dimensionalization unit 31 also adds the category label “0” or “1” to the SOM representative data sets according to the classification by the SVM, thereby creating a two-dimensional learning model (see FIG. 8C), and stores the two-dimensional learning model into the two-dimensional learning model holding unit 34.

The training data two-dimensionalization unit 32 calculates, for each image feature training data set, the SOM representative data set (see FIG. 2) that is at the minimum distance to the image feature training data set, and determines the block to which the SOM representative data set belongs to be the block to which the image feature training data set belongs. The training data two-dimensionalization unit 32 adds the block information to each image feature training data set, thereby creating the two-dimensional training data sets (see FIG. 8A), and stores the two-dimensional training data sets into the two-dimensional training data holding unit 35.

In the present embodiment, the distance function used for determining the distances between the image feature training data sets and the SOM representative data sets is the kernel function that is used by the SVM. For example, suppose that the image data set 1 included in the image feature training data sets (See FIG. 7A) is at the minimum distance to the SOM representative data set having the block number “1” among the SOM representative data sets (see FIG. 7C). In this case, the two-dimensional training data sets creating unit 32 determines that the block to which the image data set 1 belongs is the block 1, and creates the two-dimensional training data sets (see FIG. 8A) based on the determination.

The training candidate data two-dimensionalization unit 33 performs similar processing to the processing performed by the training data two-dimensionalization unit 32 in order to calculate, for each image feature training candidate data set, the block to which it belongs, and adds the block information to each image feature training candidate data set. Furthermore, the training candidate data two-dimensionalization unit 33 determines the image feature training candidate data sets having the block information to be the two-dimensional training candidate data sets (see FIG. 8B), and stores the two-dimensional training candidate data sets into the two-dimensional training candidate data holding unit 35.

For example, suppose that the image data set 1 included in the image feature training candidate data sets (See FIG. 7B) is at the minimum distance to the SOM representative data set having the block number “29” among the SOM representative data sets (see FIG. 7C). In this case, the training candidate data two-dimensionalization unit 33 determines that the block to which the image data set 1 belongs is the block 29, and creates the two-dimensional training candidate data sets (see FIG. 8B) based on the determination.

The data synthesizing unit 37 creates synthesized two-dimensional data sets. Specifically, the data synthesizing unit 37 creates synthesized two-dimensional data sets based on the blocks of the SOM, by using the two-dimensional learning model, the two-dimensional training data sets, and the two-dimensional training candidate data sets (see FIG. 9). The data synthesizing unit 37 stores the synthesized two-dimensional data sets so created into the synthesized two-dimensional data holding unit 38.

In the present embodiment, as shown in FIG. 9, the synthesized two-dimensional data sets are created by adding, to each SOM representative data sets data set, the category label of the corresponding block, the name of the image feature training data set belonging to the corresponding block, and the name of the image feature training candidate data set belonging to the corresponding block.

For example, with respect to the block number 1 in the two-dimensional learning model (see FIG. 8C), the data synthesizing unit 37 specifies the image data set having the block number 1 from among the two-dimensional training data sets (see FIG. 8A), and determines the image data set as the image feature training data set belonging to the block having the block number 1. Similarly, the data synthesizing unit 37 finds the image data set belonging to the block having the block number 1 from among the two-dimensional training candidate data sets (see FIG. 8B), and determines the image data set to be the image feature training candidate data set belonging to the block having the block number 1.

In the subsequent phase, namely the training data improving phase, the synthesized two-dimensional data sets thus created are visualized and presented to the user. Then, the image training data sets that require correction, deletion, or addition are presented to the user, and the user is instructed to improve the image training data sets.

### Training Data Improving Phase

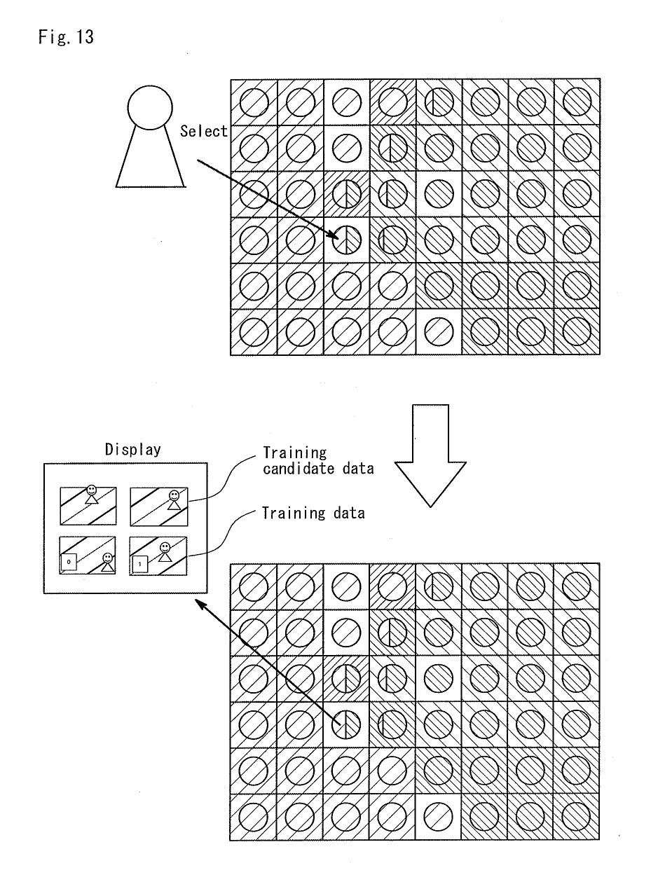

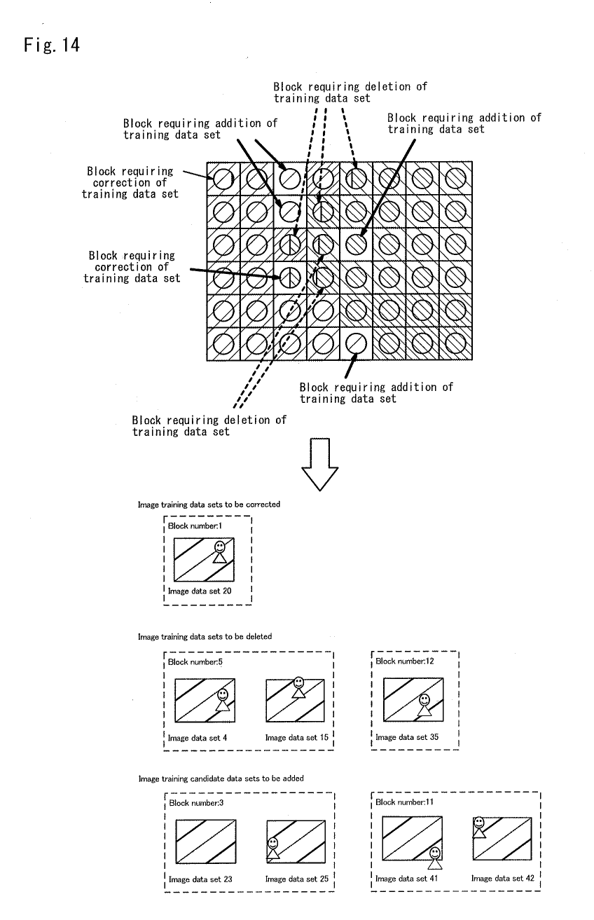

The synthesized two-dimensional data presentation unit 41 presents to the user the SVM learning model, the image training data sets, and the image training candidate data sets, by using the synthesized two-dimensional data sets (see FIG. 9) stored in the synthesized two-dimensional data holding unit 38. The following provides specific explanation with reference to FIGS. 13 and 14. FIG. 13 is a diagram illustrating an example of the synthesized two-dimensional data sets visualized in the embodiment of the present invention. FIG. 14 is a diagram illustrating an example of a case where the synthesized two-dimensional data sets illustrated in FIG. 13 require correction, deletion, or addition of image training data sets.

### [1] Presentation of SVM Learning Model

The synthesized two-dimensional data presentation unit 41 visualizes the synthesized two-dimensional data sets (see FIG. 9) held by the synthesized two-dimensional data holding unit 38, and displays the data sets in the form of a two-dimensional map. In this regard, the synthesized two-dimensional data presentation unit 41 varies the color of the blocks of the visualized two-dimensional map according to the category label of each SOM representative data set.

For example, as shown in FIG. 13, the synthesized two-dimensional data presentation unit 41 displays the blocks to which the category label “1” is attached in red, and the blocks to which the category label “0” is attached in blue. The synthesized two-dimensional data presentation unit 41 also varies the intensity of the color of each block according to the number of the image training data sets (see FIG. 6A) belonging to the block. When the number of the image training data sets belonging to a block is 6 or more, the color of the block is set to be dark, when the number is from 2 to 5, the color is set to be light, and when the number is 1 or less, the color is set to be as close as white.

Specifically, regarding the synthesized two-dimensional data sets shown in FIG. 9, suppose that the block having the block number 3 (i.e., the third block from the left in the top tier) has the category label “1” and the number of image training data sets belonging to the block is 3. In this case, the block having the block number 3 is displayed in light red on the two-dimensional map shown in FIG. 13. Note that the differences in color in FIG. 13 are represented by the differences in the type of hatching. The intensity of the color is represented by the pitch of the hatching.

### [2] Presentation of Image Training Data Sets

The synthesized two-dimensional data presentation unit 41 calculates, for each block, the proportion of the number of the image training data sets having the respective category labels, based on the image training data sets belonging to the block. As shown in FIG. 13, the synthesized two-dimensional data presentation unit 41 displays a circle in the center of each block in which not all the category labels of the image training data sets belonging to the block are the same, and colors the circle in different colors. The proportions of the different colors represent the proportions of the category labels.

Specifically, when all the image training data sets belonging to a given block in the synthesized two-dimensional data sets have the category label “1”, the two-dimensional data set presentation unit 41 displays the circle in the center of the block on the two-dimensional map (see FIG. 13) in only red. On the other hand, when a half of the image training data sets belonging to a given block has the category label “1” and the other half has the category label “0”, the synthesized two-dimensional data presentation unit 41 displays a half of the circle in the center of the block on the two-dimensional map in red, and displays the other half in blue.

In addition, as shown in FIG. 13, when the user specifies a particular block on the two-dimensional map, the synthesized two-dimensional data presentation unit 41 displays the original training data sets (see FIG. 6A) from which the image feature data sets belonging to the block have been created by transformation. For example, suppose that the user specifies a block in which the circle is colored in red and blue. Also suppose that the number of image training data sets belonging to this block is 2. In this case, the synthesized two-dimensional data presentation unit 41 displays one image training data set having the category label “1” and one image training data set having the category label “0”.

### [3] Presentation of Image Training Candidate Data Sets

When the user specifies a particular block on the two-dimensional map, the synthesized two-dimensional data presentation unit 41 may display, as shown in FIG. 13, the image training candidate data sets (see FIG. 6B) in addition to the image training data sets (see FIG. 6A) belonging to the block. For example, suppose that the user specifies a block in which the circle is colored in red and blue. In this case, the synthesized two-dimensional data presentation unit 41 displays also image training candidate data sets in addition to the image training data sets having the category label “1” and the image training data sets having the category label “0”.

### [4] Presentation of Image Training Data Sets Requiring Correction or Deletion

The training data improving unit 42 compares the image feature training data sets that are associated with a target block, with the image feature training data sets that are associated with blocks located around the target block. Then, based on the results of the comparison, the training data improving unit 42 shows an instruction on the screen to encourage the user to delete, or correct the label of, the original image training data sets from which the image feature training data sets associated with the target block have been created by transformation.

For example, with respect to the synthesized two-dimensional data sets (see FIG. 9), suppose that the blocks located at a k block distance from a particular block have the same category label and the image training data set belonging to the particular block has a different category label from the blocks around the particular block, as shown in FIG. 14. In this case, the training data improving unit 42 notifies the user of that the image training data set belonging to the particular block requires to be corrected.

Specifically, suppose that k=1. Also, with respect to the synthesized two-dimensional data sets, suppose that all the image training data sets belonging to the blocks located at a one block distance from the block having the block number 1 have the category label “1”, whereas the image training data set belonging to the block having the block number 1 has the category label “0”. In this case, the training data improving unit 42 notifies the user of that the category label of the image training data set belonging to the block having the block number 1 requires to be corrected.

For example, with respect to the synthesized two-dimensional data sets, suppose that at least one of the blocks located at a k block distance from a particular block has a different category label from the other blocks, as shown in FIG. 14. Furthermore, suppose that some of the image training data sets belonging to the particular block have a different category label from the rest of the image training data sets. In this case, the training data improving unit 42 notifies that user of that some of the image training data sets belonging to the particular block require to be deleted.

Specifically, suppose that k=1. Also, with respect to the synthesized two-dimensional data sets, suppose that at least one of the blocks located at a one block distance from the block having the block number 5 has a different category label from the rest of the blocks. Furthermore, suppose that not all the plurality of image training data sets belonging to the block having the block number 5 have a same category label. In this case, the training data improving unit 42 notifies the user of that, from among the plurality of image training data sets belonging to the block having the block number 5, the minority image training data sets in terms of the category label require to be deleted.

### [5] Presentation of Training Candidate Data Sets for Addition

When the number of image feature training data sets associated with the target block is no greater than a threshold value, the training data improving unit 42 displays, on the screen, the original image training candidate data sets from which the image feature training candidate data sets associated with the target block have been created. Then, the training data improving unit 42 instructs the user to add the image training candidate data sets to the image training data sets.

For example, as shown in FIG. 14, with respect to the synthesized two-dimensional data sets, the training data improving unit 42 determines the number of image training data sets belonging to each block, and determines whether the number is no greater than s. When determining that the number is no greater than s, the training data improving unit 42 provides the user with the image training candidate data sets belonging to the block, as the training candidate data sets that require to be added.

Specifically, suppose that s=3, and, with respect to the synthesized two-dimensional data sets, three image training data sets belong to the block having the block number 3. In this case, the training data improving unit 42 provides the user with the image training candidate data sets belonging to the block having the block number 3, as the training candidate data sets that require to be added.

### [6] Correction, Deletion, and Addition of Image Training Data Sets by User

As described in [4] and [5] above, upon being provided with information, the user corrects the category labels of image training data sets, deletes image training data sets, or adds image training data sets by adding a category label to image training candidate data sets (FIG. 9, 902). After the image training data sets are corrected, deleted, or added, machine learning is performed again.

### Effects of the Embodiment

As described above, the present embodiment can visualize the criterion for classification learned by the supervised machine learning scheme SVM using the image training data sets. Also, after learning of the image training data sets by the SVM, if there are missing image training data sets, the user is notified of that and is provided with appropriate image training candidate data sets. Therefore, the present embodiment greatly reduces the work required by the user. Furthermore, image training data sets that are inappropriate for learning are extracted from the image training data sets learned by the SVM and are presented to the user. Therefore, the present embodiment improves the accuracy of a system using machine learning.

### Application Examples

According to the present embodiment, it is image data sets that are treated as training data sets, and a description is given to the case where the SVM learning model is used as an image classification system. In the present embodiment, however, data sets other than image data sets may be treated as training data sets. The present embodiment is applicable to a text classification system and voice classification system using the SVM learning model.

### Text Classification System:

In FIG. 5, when the present embodiment is applied to a text classification system, the image training data storage unit 12 is replaced with a text training data storage unit, and the image training candidate data storage unit 13 is replaced with a text training candidate data storage unit. Furthermore, the image feature training data storage unit 14 and the image feature training candidate data storage unit 15 are replaced with a text feature training data storage unit and a text feature training candidate data storage unit, respectively.

Text training data sets are, for example, created by adding a category label “1” or “0” to the text data sets that are to be classified. In this case, the feature calculation unit 11 in FIG. 5 calculates the feature values of the text data sets. Specifically, the feature calculation unit 11 creates a numerical sequence, which represents the feature values, from information such as the number and the types of words appearing in a text and the composer of the text.

The text classification system according to the present embodiment improves the accuracy of text classification. The text classification system can be applied to, for example, a spam mail classification system using mail documents, which can be expected to improve the accuracy of spam mail classification. In this system, the target data sets to be classified by the SVM are mail documents, and the category label “1” may indicate a spam mail, and the category label “0” may indicate a normal mail.

### Voice Classification System:

In FIG. 5, when the present embodiment is applied to a voice classification system that classifies voices of people, the image training data storage unit 12 is replaced with a voice training data storage unit, and the image training candidate data storage unit 13 is replaced with a voice training candidate data storage unit. Furthermore, the image feature training data storage unit 14 and the image feature training candidate data storage unit 15 are replaced with a voice feature training data storage unit and a voice feature training candidate data storage unit, respectively.

Voice training data sets are, for example, created by adding a category label “1” or “0” to the voice data sets that are to be classified. In this case, the feature calculation unit 11 calculates the features of the voice data sets.

Specifically, the feature calculation unit 11 performs Fourier transformation on a given voice data set, and creates a numerical sequence, which represents the feature values, from information such as the frequency and the volume. The voice classification system according to the present embodiment improves the accuracy of voice classification. The voice classification system is applicable to, for example, a system in a call center for classifying the emotions of customers. In this system, the category label “1” may indicate an angry voice, and the category label “0” may indicate a normal voice.

As described above, according to the present embodiment, the training data sets are not limited to any particular type of data sets insofar as the feature values can be calculated from the data sets. The present embodiment is applicable to various kinds of systems that require machine learning.

### [Program]

A program according to the present embodiment may be a program that causes a computer to perform Steps A1 through A11 shown in FIG. 10. The machine learning apparatus 100 and machine learning method according to the present embodiment can be implemented by installing the program into a computer and causing the computer to execute the program. In this case, the central processing unit (CPU) of the computer serves as the feature calculation unit 11, the SVM learning unit 21, the SOM learning unit 22, the SVM classifying unit 25, the SOM classifying unit 26, the learning model two-dimensionalization unit 31, the training data two-dimensionalization unit 32, the training candidate data two-dimensionalization unit 33, and the data synthesizing unit 37, and performs their respective operations.

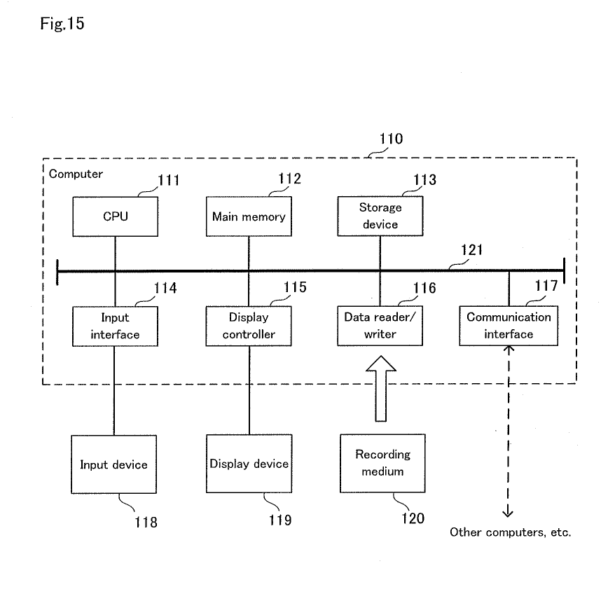

Here, referring to FIG. 15, a description is given to a computer that implements the machine learning apparatus 100 by executing the program according to the present embodiment. FIG. 15 is a block diagram illustrating an example of a computer that implements a machine learning apparatus according to the embodiment of the present invention.

As shown in FIG. 15, a computer 110 includes a CPU 111, a main memory 112, a storage device 113, an input interface 114, a display controller 115, a data reader/writer 116, and a communication interface 117. These components are connected to each other via a bus 121 so that they can communicate with each other.

The CPU 111 reads the program (codes) according to the present embodiment from the storage device 113, writes it into the main memory 112, and executes the program codes in a predetermined order, thereby performing various sorts of operations. The main memory 112 is typically a volatile storage device such as a dynamic random access memory (DRAM). The program according to the present embodiment is supplied on a computer-readable recording medium 120. The program according to the present embodiment may be distributed on the Internet to which the computer is connected via the communication interface 117.

Specific examples of the storage device 113 include a hard disk drive and a semiconductor storage device such as a flash memory. The input interface 114 mediates data transmission between the CPU 111 and an input device 118 such as a keyboard and a mouse. The display controller 115 is connected to a display device 119 and controls display on the display device 119.

The data reader/writer 116 mediates data transmission between the CPU 111 and the recording medium 120. The data reader/writer 116 reads the program from the recording medium 120, and writes the result of processing in the computer 110 into the recording medium 120. The communication interface 117 mediates data transmission between the CPU 111 and other computers.

Specific examples of the recording medium 120 include a general-purpose semiconductor storage device such as a CF (Compact Flash, registered trademark) and an SD (Secure Digital), a magnetic storage medium such as a flexible disk, and an optical storage medium such as a CD-ROM (Compact Disc Read Only Memory).

A part or all of the above embodiment can be described as, but are not limited to, the following Supplementary Notes 1 through 15.

### (Supplementary Note 1)

A machine learning apparatus including:

a feature calculation unit that transforms, into first numerical data sets, training data sets to each of which either one of two values is added as a label, each of the first numerical data sets containing a numerical value representing a feature of the corresponding training data set;

a support vector machine learning unit that learns, based on the first numerical data sets obtained by the transformation of the training data sets, and by using a support vector machine, a criterion for classification of the two values in the label, thereby creating a learning model representing the results of the learning;

a self-organizing map learning unit that projects the first numerical data sets onto a two-dimensional map by self-organizing map processing, the two-dimensional map having blocks arranged in a matrix and having representative data sets belonging to the blocks, wherein the self-organizing map learning unit causes, from among the first numerical data sets, two or more first numerical data sets with a short distance from each other to belong to adjacent blocks among the blocks of the two-dimensional map;

a support vector machine classifying unit that classifies, by using the learning model, the blocks of the two-dimensional map, onto which the first numerical data sets have been projected, and the representative data sets; and

a learning model two-dimensionalization unit that creates a two-dimensional learning model representing the results of the classification.

### (Supplementary Note 2)

The machine learning apparatus according to Supplementary Note 1 further including:

a self-organizing map classifying unit that specifies, by using the two-dimensional map, the blocks corresponding to the first numerical data sets; and

a training data two-dimensionalization unit that creates two-dimensional training data sets that associate the first numerical data sets with the blocks specified by the self-organizing map classifying unit.

### (Supplementary Note 3)

The machine learning apparatus according to Supplementary Note 2 further including a training candidate data two-dimensionalization unit,

wherein the feature calculation unit transforms, into second numerical data sets, training candidate data sets to which the label is not added, each of the second numerical data sets containing a numerical value representing a feature of the corresponding training candidate data set,

the self-organizing map learning unit specifies, by using the two-dimensional map, the blocks corresponding to the second numerical data sets, and

the training candidate data two-dimensionalization unit creates two-dimensional training candidate data sets that associate the second numerical data sets with the blocks specified by the self-organizing map learning unit.

### (Supplementary Note 4)

The machine learning apparatus according to Supplementary Note 3 further including:

a data synthesizing unit that creates synthesized two-dimensional data sets by combining the two-dimensional learning model, which represents the results of the classification, with the two-dimensional training data sets and the two-dimensional training candidate data sets; and

a synthesized two-dimensional data presentation unit that displays, on a screen, the blocks of the two-dimensional learning model representing the results of the classification, based on the synthesized two-dimensional data sets, wherein, the synthesized two-dimensional data presentation unit displays, for each of the blocks, the results of the classification, the number of the first numerical data sets associated with the corresponding block and the labels added to the first numerical data sets associated with the corresponding block.

### (Supplementary Note 5)

The machine learning apparatus according to Supplementary Note 4,

wherein, when any block is selected from among the blocks displayed on the screen, the synthesized two-dimensional data presentation unit specifies the first numerical data sets and the second numerical data sets associated with the selected block, and displays, on the screen, original training data sets and original training candidate data sets from which the first numerical data sets and the second numerical data sets have been created respectively by the transformation.

### (Supplementary Note 6)

The machine learning apparatus according to Supplementary Note 5 further including a training data improving unit,

wherein the training data improving unit compares the first numerical data sets associated with a target block and the first numerical data sets associated with blocks located around the target block, and, based on the result of the comparison, the training data improving unit displays, on the screen, an instruction to delete original training data sets from which the first numerical data sets associated with the target block have been created by the transformation, or an instruction to correct the labels added to the original training data sets.

### (Supplementary Note 7)

The machine learning apparatus according to Supplementary Note 6,

wherein, when the number of the first numerical data sets associated with the target block is no greater than a threshold value, the training data improving unit displays, on the screen, original training candidate data sets from which the second numerical data sets associated with the target block have been created by the transformation, and displays an instruction to add the original training candidate data sets to the training data sets.

### (Supplementary Note 8)

A machine learning method including:

(a) a step of transforming, into first numerical data sets, training data sets to each of which either one of two values is added as a label, each of the first numerical data sets containing a numerical value representing a feature of the corresponding training data set;

(b) a step of learning, based on the first numerical data sets obtained by the transformation of the training data sets, and by using a support vector machine, a criterion for classification of the two values in the label, thereby creating a learning model representing the results of the learning;

(c) a step of projecting the first numerical data sets onto a two-dimensional map by self-organizing map processing, the two-dimensional map having blocks arranged in a matrix and having representative data sets belonging to the blocks, wherein the projection is performed such that, from among the first numerical data sets, two or more first numerical data sets with a short distance from each other belong to adjacent blocks or a same block among the blocks of the two-dimensional map;

(d) a step of classifying, by using the learning model created in the step (b), the blocks of the two-dimensional map and the representative data sets; and

(e) a step of creating a two-dimensional learning model representing the results of the classification performed in the step (d).

### (Supplementary Note 9)

The machine learning method according to Supplementary Note 8 further including:

(f) a step of specifying, by using the two-dimensional map, the blocks corresponding to the first numerical data sets; and

(g) a step of creating two-dimensional training data sets that associate the first numerical data sets with the specified blocks.

### (Supplementary Note 10)

The machine learning method according to Supplementary Note 9,

wherein in the step (a), training candidate data sets to which the label is not added are transformed into second numerical data sets, each of the second numerical data sets containing a numerical value representing a feature of the corresponding training candidate data set,

in the step (f), the blocks corresponding to the second numerical data sets are specified by using the two-dimensional map, and

the machine learning method further includes (g) a step of creating two-dimensional training candidate data sets that associate the second numerical data sets with the specified blocks.

### (Supplementary Note 11)

The machine learning method according to Supplementary Note 10 further including:

(h) a step of creating synthesized two-dimensional data sets by combining the two-dimensional learning model, which represents the results of the classification, with the two-dimensional training data sets and the two-dimensional training candidate data sets; and

(i) a step of displaying, on a screen, the blocks of the two-dimensional learning model representing the results of the classification, based on the synthesized two-dimensional data sets, wherein, for each of the blocks, the results of the classification, the number of the first numerical data sets associated with the corresponding block and the labels added to the first numerical data sets associated with the corresponding block are displayed.

### (Supplementary Note 12)

The machine learning method according to Supplementary Note 11,

wherein, when any block is selected from among the blocks displayed on the screen in the step (i), the first numerical data sets and the second numerical data sets associated with the selected block are specified, and original training data sets and original training candidate data sets from which the first numerical data sets and the second numerical data sets have been created respectively by the transformation are displayed on the screen.

### (Supplementary Note 13)

The machine learning method according to Supplementary Note 12 further including,

(j) a step of comparing the first numerical data sets associated with a target block and the first numerical data sets associated with blocks located around the target block, and, based on the result of the comparison, displaying, on the screen, an instruction to delete original training data sets from which the first numerical data sets associated with the target block have been created by the transformation, or an instruction to correct the labels added to the original training data sets.

### (Supplementary Note 14)

The machine learning method according to Supplementary Note 13 further including

(k) a step of, when the number of the first numerical data sets associated with the target block is no greater than a threshold value, displaying, on the screen, original training candidate data sets from which the second numerical data sets associated with the target block have been created by the transformation, and displaying an instruction to add the original training candidate data sets to the training data sets.

### (Supplementary Note 15)

A non-transitory computer-readable recording medium that stores a program including an instruction for causing a computer to perform:

(a) a step of transforming, into first numerical data sets, training data sets to each of which either one of two values is added as a label, each of the first numerical data sets containing a numerical value representing a feature of the corresponding training data set;

(b) a step of learning, based on the first numerical data sets obtained by the transformation of the training data sets, and by using a support vector machine, a criterion for classification of the two values in the label, thereby creating a learning model representing the results of the learning;

(c) a step of projecting the first numerical data sets onto a two-dimensional map by self-organizing map processing, the two-dimensional map having blocks arranged in a matrix and having representative data sets belonging to the blocks, wherein the projection is performed such that, from among the first numerical data sets, two or more first numerical data sets with a short distance from each other belong to adjacent blocks or a same block among the blocks of the two-dimensional map;

(d) a step of classifying, by using the learning model created in the step (b), the blocks of the two-dimensional map and the representative data sets; and

(e) a step of creating a two-dimensional learning model representing the results of the classification performed in the step (d).

### (Supplementary Note 16)

The non-transitory computer-readable recording medium according to Supplementary Note 15, the program further including an instruction for causing the computer to perform:

(f) a step of specifying, by using the two-dimensional map, the blocks corresponding to the first numerical data sets; and

(g) a step of creating two-dimensional training data sets that associate the first numerical data sets with the specified blocks.

### (Supplementary Note 17)

The non-transitory computer-readable recording medium according to Supplementary Note 16,

wherein, in the step (a), training candidate data sets to which the label is not added are transformed into second numerical data sets, each of the second numerical data sets containing a numerical value representing a feature of the corresponding training candidate data set,

in the step (f), the blocks corresponding to the second numerical data sets are specified by using the two-dimensional map, and

the program further includes an instruction for causing the computer to perform (g) a step of creating two-dimensional training candidate data sets that associate the second numerical data sets with the specified blocks.

### (Supplementary Note 18)

The non-transitory computer-readable recording medium according to Supplementary Note 17,

wherein the program further includes an instruction for causing the computer to perform:

(h) a step of creating synthesized two-dimensional data sets by combining the two-dimensional learning model, which represents the results of the classification, with the two-dimensional training data sets and the two-dimensional training candidate data sets; and

(i) a step of displaying, on a screen, the blocks of the two-dimensional learning model representing the results of the classification, based on the synthesized two-dimensional data sets, wherein, for each of the blocks, the results of the classification, the number of the first numerical data sets associated with the corresponding block and the labels added to the first numerical data sets associated with the corresponding block are displayed.

### (Supplementary Note 19)

The non-transitory computer-readable recording medium according to Supplementary Note 18,

wherein, when any block is selected from among the blocks displayed on the screen in the step (i), the first numerical data sets and the second numerical data sets associated with the selected block are specified, and original training data sets and original training candidate data sets from which the first numerical data sets and the second numerical data sets have been created respectively by the transformation are displayed on the screen.

### (Supplementary Note 20)

The non-transitory computer-readable recording medium according to Supplementary Note 19,

wherein the program further includes an instruction for causing the computer to perform:

(j) a step of comparing the first numerical data sets associated with a target block and the first numerical data sets associated with blocks located around the target block, and, based on the result of the comparison, displaying, on the screen, an instruction to delete original training data sets from which the first numerical data sets associated with the target block have been created by the transformation, or an instruction to correct the labels added to the original training data sets.

### (Supplementary Note 21)

The non-transitory computer-readable recording medium according to Supplementary Note 20,

wherein the program further includes an instruction for causing the computer to perform:

(k) a step of, when the number of the first numerical data sets associated with the target block is no greater than a threshold value, displaying, on the screen, original training candidate data sets from which the second numerical data sets associated with the target block have been created by the transformation, and displaying an instruction to add the original training candidate data sets to the training data sets.
Reference Document 1: Kouji TSUDA, “Overview of Support Vector Machine”, Journal of the Institute of Electronics, Information, and Communication Engineers, pp. 460-466, 2000-06-25
Reference Document 2: T. Kohonen, “Self-Organizing Maps”, Springer Series in Information Sciences
Reference Document 3: Hironobu FUJIYOSHI, “Gradient-Based Feature Extraction—SIFT and HOG—”, Information Processing Society of Japan, Research Report CVIM 160, pp. 211-224, 2007
Reference Document 4: SHEN Linlin, “Gabor Features and Support Vector Machine for Face Identification”, Biomedical fuzzy and human sciences: the official journal of the Biomedical Fuzzy Systems Association 14(1), pp. 61-66, 2009-01-00
Reference Document 5: Ryo INOKUCHI, Sadaaki MIYAMOTO, “LVQ Clustering and SOM Using a Kernel Function”, Intelligence and Information (Journal of Japan Society for Fuzzy Theory and Intelligent Informatics), Vol. 17, No. 1, pp. 88-91, 2005

As described above, the present invention is capable of saving the user the trouble of collecting training data sets, while improving the accuracy of processing using supervised machine learning. The present invention is applicable to various kinds of systems that require machine learning, such as an intrusion detection system, a text classification system, and a voice classification system.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A machine learning apparatus comprising:
a feature calculation unit that transforms, into first numerical data sets, training data sets to each of which either one of two values is added as a label, each of the first numerical data sets containing a numerical value representing a feature of the corresponding training data set;
a support vector machine learning unit that learns, based on the first numerical data sets obtained by the transformation of the training data sets, and by using a support vector machine, a criterion for classification of the two values in the label, thereby creating a learning model representing the results of the learning;
a self-organizing map learning unit that projects the first numerical data sets onto a two-dimensional map by self-organizing map processing, the two-dimensional map having blocks arranged in a matrix and having representative data sets belonging to the blocks, wherein the self-organizing map learning unit causes, from among the first numerical data sets, two or more first numerical data sets with a short distance from each other to belong to adjacent blocks among the blocks of the two-dimensional map;
a support vector machine classifying unit that classifies, by using the learning model, the blocks of the two-dimensional map, onto which the first numerical data sets have been projected, and the representative data sets; and
a learning model two-dimensionalization unit that creates a two-dimensional learning model representing the results of the classification.

2. The machine learning apparatus according to claim 1 further comprising:
a self-organizing map classifying unit that specifies, by using the two-dimensional map, the blocks corresponding to the first numerical data sets; and
a training data two-dimensionalization unit that creates two-dimensional training data sets that associate the first numerical data sets with the blocks specified by the self-organizing map classifying unit.

3. The machine learning apparatus according to claim 2 further comprising a training candidate data two-dimensionalization unit,
wherein the feature calculation unit transforms, into second numerical data sets, training candidate data sets to which the label is not added, each of the second numerical data sets containing a numerical value representing a feature of the corresponding training candidate data set,
the self-organizing map learning unit specifies, by using the two-dimensional map, the blocks corresponding to the second numerical data sets, and
the training candidate data two-dimensionalization unit creates two-dimensional training candidate data sets that associate the second numerical data sets with the blocks specified by the self-organizing map learning unit.

4. The machine learning apparatus according to claim 3 further comprising:
a data synthesizing unit that creates synthesized two-dimensional data sets by combining the two-dimensional learning model, which represents the results of the classification, with the two-dimensional training data sets and the two-dimensional training candidate data sets; and
a synthesized two-dimensional data presentation unit that displays, on a screen, the blocks of the two-dimensional learning model representing the results of the classification, based on the synthesized two-dimensional data sets, wherein, the synthesized two-dimensional data presentation unit displays, for each of the blocks, the results of the classification, the number of the first numerical data sets associated with the corresponding block and the labels added to the first numerical data sets associated with the corresponding block.

5. The machine learning apparatus according to claim 4,
wherein, when any block is selected from among the blocks displayed on the screen, the synthesized two-dimensional data presentation unit specifies the first numerical data sets and the second numerical data sets associated with the selected block, and displays, on the screen, original training data sets and original training candidate data sets from which the first numerical data sets and the second numerical data sets have been created respectively by the transformation.

6. The machine learning apparatus according to claim 5 further comprising a training data improving unit,
wherein the training data improving unit compares the first numerical data sets associated with a target block and the first numerical data sets associated with blocks located around the target block, and, based on the result of the comparison, the training data improving unit displays, on the screen, an instruction to delete original training data sets from which the first numerical data sets associated with the target block have been created by the transformation, or an instruction to correct the labels added to the original training data sets.

7. The machine learning apparatus according to claim 6,
wherein, when the number of the first numerical data sets associated with the target block is no greater than a threshold value, the training data improving unit displays, on the screen, original training candidate data sets from which the second numerical data sets associated with the target block have been created by the transformation, and displays an instruction to add the original training candidate data sets to the training data sets.

8. A machine learning method comprising:
(a) a step of transforming, into first numerical data sets, training data sets to each of which either one of two values is added as a label, each of the first numerical data sets containing a numerical value representing a feature of the corresponding training data set;
(b) a step of learning, based on the first numerical data sets obtained by the transformation of the training data sets, and by using a support vector machine, a criterion for classification of the two values in the label, thereby creating a learning model representing the results of the learning;
(c) a step of projecting the first numerical data sets onto a two-dimensional map by self-organizing map processing, the two-dimensional map having blocks arranged in a matrix and having representative data sets belonging to the blocks, wherein the projection is performed such that, from among the first numerical data sets, two or more first numerical data sets with a short distance from each other belong to adjacent blocks or a same block among the blocks of the two-dimensional map;
(d) a step of classifying, by using the learning model created in the step (b), the blocks of the two-dimensional map and the representative data sets; and
(e) a step of creating a two-dimensional learning model representing the results of the classification performed in the step (d).

9. A non-transitory computer-readable recording medium that stores a program including an instruction for causing a computer to perform:
(a) a step of transforming, into first numerical data sets, training data sets to each of which either one of two values is added as a label, each of the first numerical data sets containing a numerical value representing a feature of the corresponding training data set;
(b) a step of learning, based on the first numerical data sets obtained by the transformation of the training data sets, and by using a support vector machine, a criterion for classification of the two values in the label, thereby creating a learning model representing the results of the learning;
(c) a step of projecting the first numerical data sets onto a two-dimensional map by self-organizing map processing, the two-dimensional map having blocks arranged in a matrix and having representative data sets belonging to the blocks, wherein the projection is performed such that, from among the first numerical data sets, two or more first numerical data sets with a short distance from each other belong to adjacent blocks or a same block among the blocks of the two-dimensional map;
(d) a step of classifying, by using the learning model created in the step (b), the blocks of the two-dimensional map and the representative data sets; and
(e) a step of creating a two-dimensional learning model representing the results of the classification performed in the step (d).
